(19) United States
(12) Patent Application Publication
(10) Pub. No.: US 2025/0310939 A1
(43) Pub. Date: Oct. 2, 2025

(54) 6G VIRTUAL CELL WITH DIFFERENT NUMEROLOGIES FOR DIFFERENT SUB-BANDS

(71) Applicant: QUALCOMM Incorporated, San Diego, CA (US)

(72) Inventors: Kazuki TAKEDA, Tokyo (JP); Kianoush HOSSEINI, San Diego, CA (US)

(21) Appl. No.: 18/622,648

(22) Filed: Mar. 29, 2024

(51) Int. Cl. H04W 72/0453; H04W 72/21; H04W 72/23

(52) U.S. Cl. CPC H04W 72/0453; H04W 72/21; H04W 72/23

(57) ABSTRACT

This disclosure provides approaches for enhancing the efficiency of dynamic spectrum sharing and carrier aggregation in 6G and later networks. The proposed methods and apparatuses allow for the configuration of control and data channels to accommodate multiple non-contiguous sub-bands with different numerologies within a virtual cell. Methods of wireless communication performable at a User Equipment (UE) are accordingly provided which enable the UE to obtain a configuration of a control channel or a data channel in a cell, and receive or transmit information in at least one of the control channel or the data channel based on the configuration. The cell includes a plurality of non-contiguous frequency bands associated with different numerologies. The control channel or the data channel may be allocated in the non-contiguous frequency bands associated with a single numerology of the different numerologies, or the non-contiguous frequency bands associated with each numerology of the different numerologies.

### TECHNICAL FIELD

The present disclosure generally pertains to the field of wireless communication, and more particularly, to the configuration of control and data channels in wireless communication systems that accommodates multiple non-contiguous sub-bands with different numerologies within a virtual cell for 6G network deployments.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in an apparatus for wireless communication, which may be a user equipment (UE). The apparatus includes one or more memories, and one or more processors each communicatively coupled with at least one of the one or more memories. The one or more processors, individually or in any combination, are operable to cause the apparatus to obtain a configuration of a control channel or a data channel in a cell, the cell including a plurality of non-contiguous frequency bands associated with different numerologies, the control channel or the data channel being allocated in: one or more of the non-contiguous frequency bands associated with a single numerology of the different numerologies, or one or more of the non-contiguous frequency bands associated with each numerology of the different numerologies; and receive or transmit information in at least one of the control channel or the data channel based on the configuration.

Another innovative aspect of the subject matter described in this disclosure may be implemented in a method for wireless communication performable at a UE. The method includes obtaining a configuration of a control channel or a data channel in a cell, the cell including a plurality of non-contiguous frequency bands associated with different numerologies, the control channel or the data channel being allocated in: one or more of the non-contiguous frequency bands associated with a single numerology of the different numerologies, or one or more of the non-contiguous frequency bands associated with each numerology of the different numerologies; and receiving or transmitting information in at least one of the control channel or the data channel based on the configuration.

Another innovative aspect of the subject matter described in this disclosure may be implemented in an apparatus for wireless communication, which may be a UE. The apparatus includes means for obtaining a configuration of a control channel or a data channel in a cell, the cell including a plurality of non-contiguous frequency bands associated with different numerologies, the control channel or the data channel being allocated in: one or more of the non-contiguous frequency bands associated with a single numerology of the different numerologies, or one or more of the non-contiguous frequency bands associated with each numerology of the different numerologies; and means for receiving or transmitting information in at least one of the control channel or the data channel based on the configuration.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first subframe within a 5G NR frame structure.

FIG. 2B is a diagram illustrating an example of DL channels within a 5G NR subframe.

FIG. 2C is a diagram illustrating an example of a second subframe within a 5G NR frame structure.

FIG. 2D is a diagram illustrating an example of UL channels within a 5G NR subframe.

FIG. 3 is a block diagram illustrating an example of a base station and a UE involved in wireless communication.

FIG. 4 is a diagram illustrating an example of a carrier aggregation scenario considered for network deployments.

FIG. 5 is a diagram illustrating an example of a scenario including refarmed spectrum challenges.

FIG. 6 is a diagram illustrating an example of a virtual cell, which involves the aggregation of multiple frequency bands or sub-bands.

FIGS. 7A-7B are diagrams illustrating examples of Bandwidth Part (BWP) configurations.

FIG. 8 is a diagram illustrating an example of a virtual cell formed by sub-bands with different numerologies.

FIGS. 9A-9B are diagrams illustrating examples of a virtual cell that contains multiple sub-bands with different numerologies and which focuses on the handling of the Physical Downlink Control Channel (PDCCH).

FIG. 10 is a diagram illustrating another example of a virtual cell with different numerologies for sub-bands for handling the PDCCH.

FIGS. 11A-11C are diagrams illustrating other examples of an aspect for handling the PDCCH in a virtual cell with different numerologies for sub-bands.

FIGS. 12A-12B are diagrams illustrating examples of a virtual cell with different sub-bands and different numerologies in which the UE may handle a Physical Uplink Control Channel (PUCCH).

FIG. 13 is a diagram illustrating another example of a virtual cell with different sub-bands and different numerologies in which the UE may handle a PUCCH.

FIG. 14 is a diagram illustrating another example of a virtual cell with different sub-bands and different numerologies in which the UE may handle PUCCH.

FIGS. 15A-15B are diagrams illustrating further examples of a virtual cell with different sub-bands and different numerologies in which the UE may handle PUCCH.

FIG. 16 is a diagram illustrating an example of a physical downlink shared channel (PDSCH) or a physical uplink shared channel (PUSCH) for virtual cells with different numerologies.

FIG. 17 is a diagram illustrating another example of a PDSCH or PUSCH for virtual cells with different numerologies.

FIG. 18 is a diagram illustrating an example of a concurrent PUCCH and PUSCH for virtual cells with different sub-bands and different numerologies.

FIG. 19 is a diagram illustrating another example of a concurrent PUCCH and PUSCH for virtual cells with different sub-bands and different numerologies.

FIG. 20 is a diagram illustrating an example of a call flow between a base station and a UE.

FIG. 21 is a flowchart of an example method of wireless communication performable at a UE.

FIG. 22 is a diagram illustrating an example of a hardware implementation for an apparatus that may be a UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

6G networks aim to enhance throughput by employing dynamic spectrum sharing and carrier aggregation. However, these techniques face challenges, particularly in low band cases where non-contiguous spectrums are aggregated to meet minimum channel bandwidth (CBW) requirements. To address this, virtual cells have been introduced, which allow for non-contiguous sub-bands within a single cell. However, these are also limited as they typically require the same subcarrier spacing (SCS) for different sub-bands. Current bandwidth part (BWP) configurations also only indicate one SCS at a time, limiting the potential for dynamic spectrum sharing and capping throughput. While there are exceptions for specific information like Synchronization Signal Block/Random Access Channel (SSB/RACH), in general, data and control channels are not configured for different numerologies. These channels include the physical downlink control channel (PDCCH), physical uplink control channel (PUCCH), physical downlink shared channel (PDSCH), and physical uplink shared channel (PUSCH). Therefore, there is a need for virtual cell configurations that allow for different numerologies for non-contiguous sub-bands, which would increase the applicability of dynamic spectrum sharing and enhance throughput. Aspects of the present disclosure present various techniques for configuring different channels in a virtual cell with different numerologies, including aspects of resource allocation, blind decoding/Control Channel Element (BD/CCE) counting, and frequency hopping, when resources of different channels (PDCCH, PUCCH, PDSCH, and PUSCH) are spread across different numerologies in a virtual cell.

Accordingly, various aspects of the subject matter described in this disclosure relate generally to wireless communication and more particularly to dynamic spectrum sharing and carrier aggregation in 6G networks. Various aspects specifically relate to the configuration of control and data channels in a virtual cell that includes multiple non-contiguous frequency bands associated with different numerologies. In various examples, apparatuses and methods are provided in which a user equipment (UE) obtains a configuration of a control channel or a data channel in a cell, and receives or transmits information in at least one of the control channel or the data channel based on the configuration. The cell includes a plurality of non-contiguous frequency bands associated with different numerologies. The control channel or the data channel may be allocated in: one or more of the non-contiguous frequency bands associated with a single numerology of the different numerologies, or one or more of the non-contiguous frequency bands associated with each numerology of the different numerologies.

Various aspects also relate to configuration and handling of PDCCH, PUCCH, PDSCH, and PUSCH. For example, some aspects relate to the monitoring of the PDCCH in one or more of the non-contiguous frequency bands associated with a single numerology or each numerology of the different numerologies. The configuration may indicate a quantity of blind decoding attempts and a quantity of non-overlapped Control Channel Elements (CCEs) for PDCCH monitoring in a time period for the cell, with these quantities being capped by a limit associated with the single numerology or each of the different numerologies for the PDCCH. Moreover, other aspects relate to handling of PUCCH. For example, the UE may be configured with a plurality of PUCCH resources, each including one or more time-frequency resources associated with a single numerology or each numerology of the different numerologies. The UE may transmit in one of the PUCCH resources allocated in the one or more of the non-contiguous frequency bands associated with a single numerology during a time period, or transmit in multiple ones of the PUCCH resources allocated in the one or more of the non-contiguous frequency bands associated with each numerology of the different numerologies simultaneously during a single time period. Furthermore, other aspects relate to the handling of the PDSCH or the PUSCH. For example, the UE may receive Downlink Control Information (DCI) scheduling the PDSCH or the PUSCH in the one or more of the non-contiguous frequency bands associated with a single numerology or each numerology of the different numerologies. The UE may then receive the PDSCH or transmit the PUSCH in the one or more of the non-contiguous frequency bands associated with the single numerology or each numerology of the different numerologies, where individual code blocks in the PDSCH or the PUSCH are respectively allocated in the one or more of the non-contiguous frequency bands associated with a single numerology. Lastly, other aspects relate to the concurrent transmission of the PUCCH and the PUSCH. For example, the UE may transmit the PUCCH in one or more of the non-contiguous frequency bands associated with one or multiple of the different numerologies, and transmit the PUSCH, concurrently with the PUCCH, in a different one or more of the non-contiguous frequency bands associated with one or multiple of the different numerologies. In some cases, the PUCCH may be multiplexed on the PUSCH in either the one or more of the non-contiguous frequency bands associated with a reference numerology of the different numerologies, or the one or more of the non-contiguous frequency bands associated with each numerology of the different numerologies.

Thus, particular aspects of the subject matter described in this disclosure may be implemented to realize one or more potential advantages. For example, the described methods and apparatuses may enhance the efficiency of dynamic spectrum sharing and carrier aggregation in 6G networks. This may be achieved by allowing for the configuration of control and data channels to accommodate multiple non-contiguous sub-bands with different numerologies within a virtual cell. Other advantages relate to the handling of the PDCCH, the PUCCH, the PDSCH, or the PUSCH. For example, with respect to the PDCCH, the configuration may indicate a quantity of blind decoding attempts and a quantity of non-overlapped CCEs for PDCCH monitoring in a time period for the cell, with these quantities being capped by a limit associated with the single numerology or each of the different numerologies for the PDCCH. These quantities may enhance the reliability of downlink control information. Moreover, with respect to the PUCCH, the UE may be configured with a plurality of PUCCH resources, each including one or more time-frequency resources associated with a single numerology or each numerology of the different numerologies. This configuration may improve the efficiency of uplink control information transmission. Further, with respect to PDSCH and PUSCH, the UE may receive DCI scheduling the PDSCH or the PUSCH in the one or more of the non-contiguous frequency bands associated with a single numerology or each numerology of the different numerologies. This approach may optimize the use of the available spectrum for downlink and uplink data transmission. Additionally, with respect to concurrent transmission of the PUCCH and the PUSCH, the UE may transmit the PUCCH in one or more of the non-contiguous frequency bands associated with one or multiple of the different numerologies, and transmit the PUSCH, concurrently with the PUCCH, in a different one or more of the non-contiguous frequency bands associated with one or multiple of the different numerologies. This configuration may enhance the reliability of simultaneous uplink control and data transmission. Thus, all of these aspects may allow for more efficient use of the available spectrum and enhance the reliability of the communication, particularly in terms of downlink control information, uplink control information transmission, downlink and uplink data transmission, and simultaneous uplink control and data transmission.

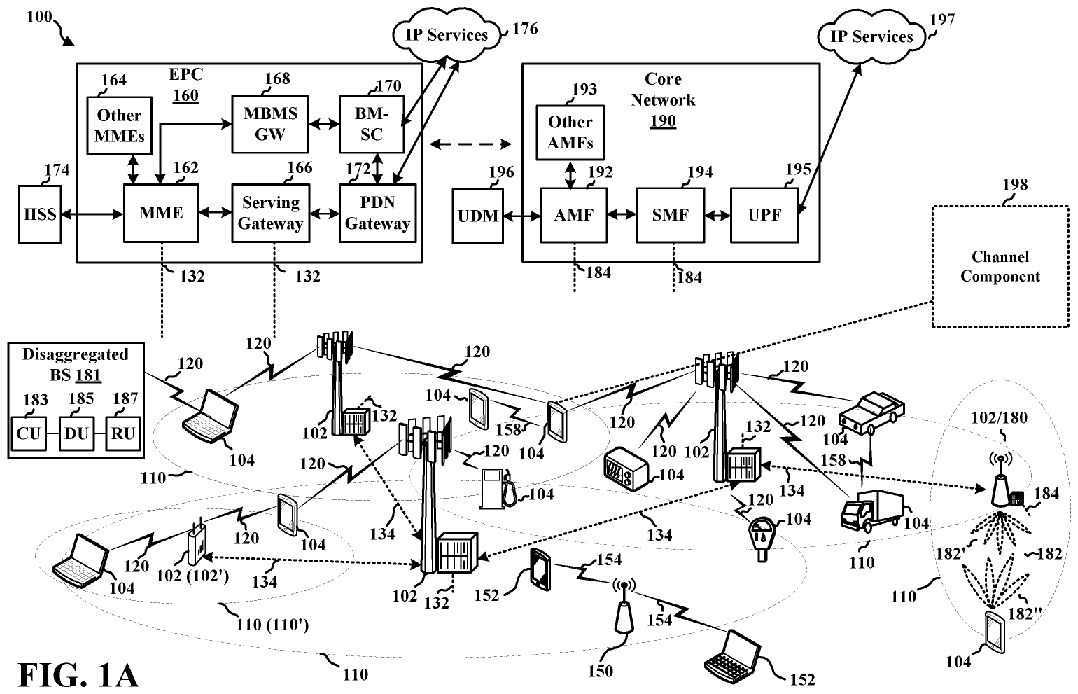

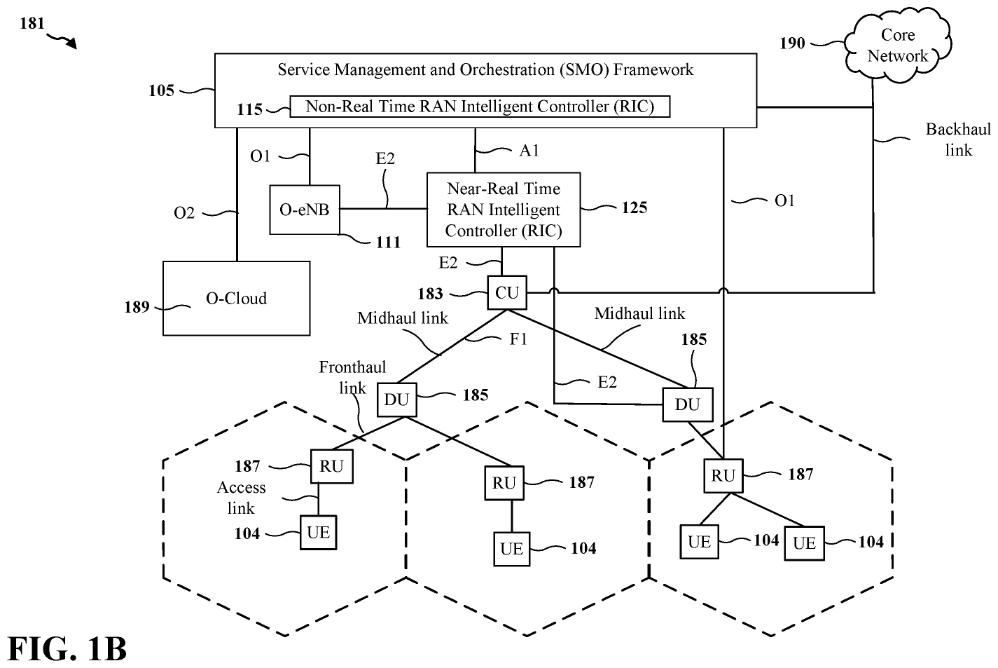

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FRI (410 MHz-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 1B shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUS 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the E1 interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may be implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open cNB (O-eNB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (A1/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

Referring to FIGS. 1A and 1B, in certain aspects, the UE 104 may include a channel component 198 that is configured to obtain a configuration of a control channel or a data channel in a cell, the cell including a plurality of non-contiguous frequency bands associated with different numerologies, the control channel or the data channel being allocated in: one or more of the non-contiguous frequency bands associated with a single numerology of the different numerologies, or one or more of the non-contiguous frequency bands associated with each numerology of the different numerologies; and receive or transmit information in at least one of the control channel or the data channel based on the configuration. The UE may obtain the configuration from, receive the information from, or transmit the information to, base station 102/180, disaggregated base station 181, a component of disaggregated base station 181 such as CU 183, DU 185, or RU 187, or some other network entity.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

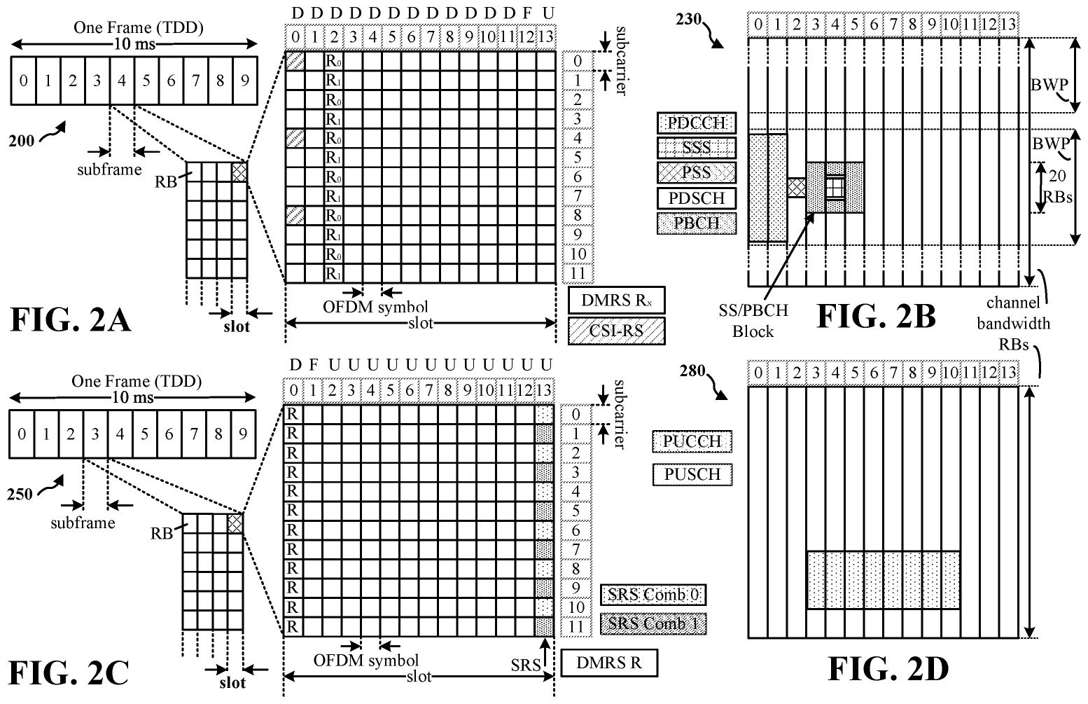

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2 μ*15 kilohertz (kHz), where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE may determine a physical cell identifier (PCI). Based on the PCI, the UE may determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

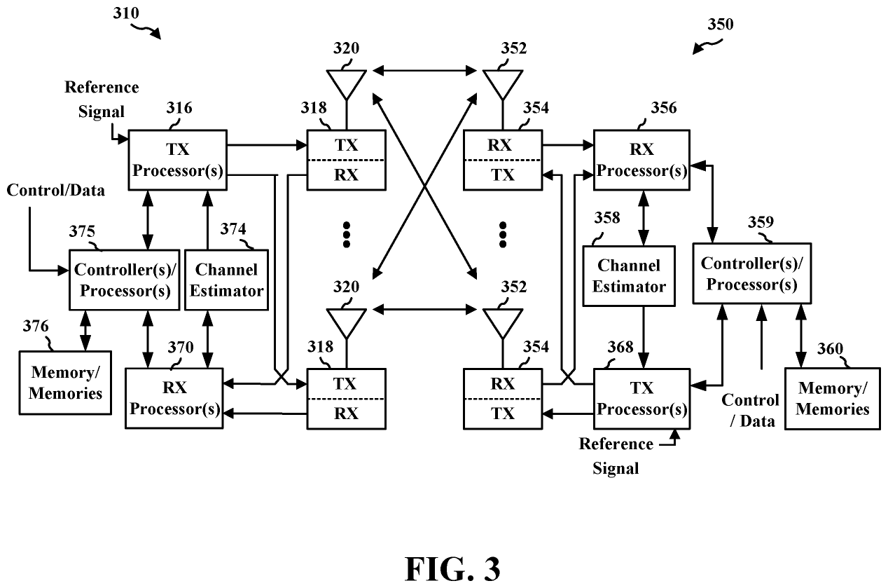

FIG. 3 is a block diagram of a base station 310 such as base station 102/180 in communication with a UE 350 such as UE 104 in an access network. IP packets from the EPC 160 may be provided to one or more controllers/processors 375 of base station 310. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer protocol data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 of base station 310 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 of UE 350 implement layer 1 functionality associated with various signal processing functions. The one or more RX processors 356 may perform spatial processing on the information to recover any spatial streams destined for the UE 350. If multiple spatial streams are destined for the UE 350, they may be combined by the one or more RX processors 356 into a single OFDM symbol stream. The one or more RX processors 356 then convert the OFDM symbol stream from the time-domain to the frequency domain using a Fast Fourier Transform (FFT). The frequency domain signal comprises a separate OFDM symbol stream for each subcarrier of the OFDM signal.

The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the one or more controllers/processors 359 of UE 350, which implement layer 3 and layer 2 functionality.

The one or more controllers/processors 359 may each be associated with one or more memories 360 that store program codes and data. The one or more memories 360, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). The one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with transmission by the base station 310, the one or more controllers/processors 359 of UE 350 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). The one or more controllers/processors 375 provide demultiplexing between transport and logical channels, packet reassembly, deciphering, header decompression, control signal processing to recover IP packets from the UE 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 368, the one or more RX processors 356, and the one or more controllers/processors 359, may be configured to perform aspects in connection with channel component 198 of FIG. 1A.

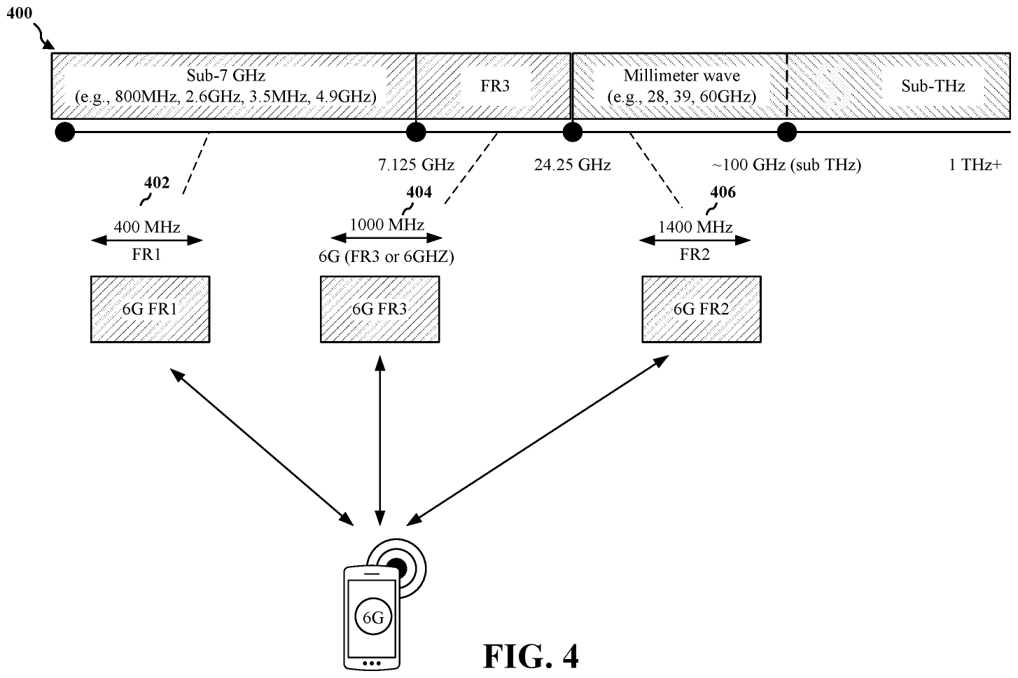

FIG. 4 illustrates an example 400 of a carrier aggregation scenario considered for 6G deployments. Using dynamic spectrum sharing and aggregation techniques, the 6G network may be designed to offer a superior user experience and overall performance compared to 5G. For instance, UE 104 may be configured to use carrier aggregation (CA) to simultaneously communicate in a sub-7 GHz frequency range 402 (FR1) with a peak throughput envelope of 18 Gbps, a mid-band frequency range 404 (FR3) with a peak throughput envelope of 42 Gbps, and a millimeter wave frequency range 406 (FR2) with a peak throughput envelope of 45 Gbps. This configuration may allow for a total peak throughput envelope of 105 Gbps to be theoretically achieved. However, practically, the universal availability of new and contiguous spectrum with good coverage for 6G deployment may still be a challenge.

Currently, cell sites with one or multiple component carriers (CCs) face several challenges. The system bandwidth of each CC may span a set of resource blocks that are contiguous in frequency, which bandwidth may be lower bounded by a minimum channel bandwidth (CBW) of the UE 104. This minimum CBW of the UE may be radio access technology (RAT)-dependent and hard-coded for each operating band. For instance, the minimum CBW may be 1.4 MHz for LTE or 5, 10, or 20 MHZ (SCS and band dependent) for NR FR1. When dealing with a refarmed spectrum that has a narrow bandwidth and is scattered in frequency, leveraging such narrow band resources for dynamic spectrum sharing or CA as envisioned in FIG. 4 may be challenging. For instance, without spectrum aggregation with other CCs to meet the minimum CBW, one or multiple refarmed CC with a bandwidth of less than that CBW may not be suitable for standalone (SA) deployment of NR/5G.

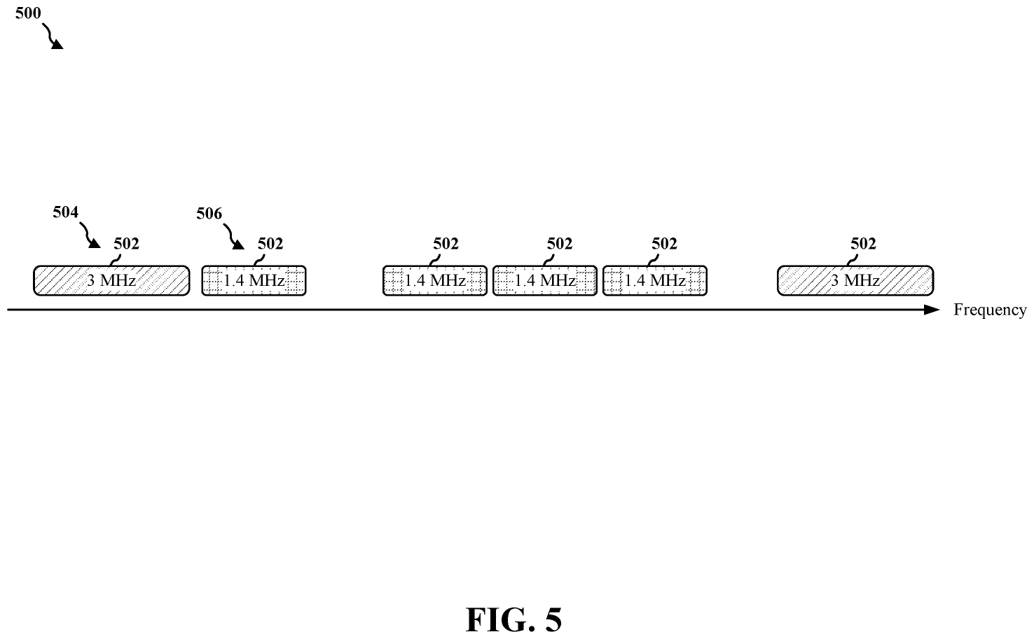

FIG. 5 illustrates an example 500 of a scenario depicting this refarmed spectrum challenge. In the context of 4G and 5G, a system bandwidth 502 may be defined for each carrier of the UE, with each carrier having a specific subcarrier spacing and bandwidth. Data may be mapped on each carrier, and these carriers may be processed independently and in parallel for carrier aggregation. However, complications may arise when considering low band frequencies, where operators may have multiple carriers each with a very narrow bandwidth. For instance, an operator may have one carrier 504 with a 3 MHz carrier bandwidth and another carrier 506 with a 1.4 MHZ carrier bandwidth. When these two bandwidths are combined, they may still fall short of a 5 MHz minimum CBW for SA 5G deployments. Therefore, in view of the relatively narrow total bandwidth of contiguous sets of carriers, it would be helpful for multiple non-contiguous carriers to be controlled independently for carrier aggregation to achieve the desired throughput of FIG. 4.

To overcome these CBW restrictions on spectrum refarming and CA, improve the utilization efficiency of fragmented or refarmed resources, and enhance the co-existence of different use cases, a virtual cell may be applied. A virtual cell, as opposed to a physical cell with a physical frequency range and contiguous subcarriers, is a cell that is mapped to multiple physical cells or non-contiguous subcarriers. A virtual cell may be considered as if it were just one cell for purposes of carrier aggregation. Thus, in contrast to a physical cell or component carrier, a virtual cell may be configured with non-contiguous sub-bands.

There may be one or multiple conditions to form a virtual cell. One condition may regard the frequency range, namely that a virtual cell contains sub-bands belonging to the same frequency range. Thus, sub-bands in a virtual cell would fall within a specific range of frequencies. Another condition may regard the gap of two adjacent sub-bands, namely that the gap is less than or equal to a pre-configured or determined threshold F_{MGAP} MHz. Thus, the distance in frequency between two sub-bands in a virtual cell would be within a certain limit. Another condition may regard the aggregated bandwidth, namely that the aggregated bandwidth across all the sub-bands is less than or equal to a pre-configured or determined threshold F_{MSUM} MHz. Thus, the total bandwidth of all the sub-bands in a virtual cell would be within a certain limit. Another condition may regard the numerology, namely that all the sub-bands use the same subcarrier spacing (SCS) and cyclic prefix (CP)-length. Thus, all the sub-bands in a virtual cell would use the same settings for these parameters. Another condition may regard the receive (Rx) timing difference (RTD), namely that the RTD of downlink (DL) channels or Reference Signals (RSs) across the sub-bands would be equal to T_{MRTD}<T_{CP.ref_SCS}/L. Thus, the timing difference between the reception of signals from different sub-bands would be within a certain limit. Another condition may regard the transmit (Tx) timing difference (TTD), namely that the TTD is the same for all uplink (UL) channels or RSs across the sub-bands. Thus, the timing difference between the transmission of signals to different sub-bands would be the same. Another condition may regard the receive (Rx) power spectral density (RPSD) imbalance between sub-bands, namely that the imbalance in RPSD between subbands would be within P_{MRPD} dB. Thus, the difference in power intensity between the signals received from different sub-bands would be within a certain limit.

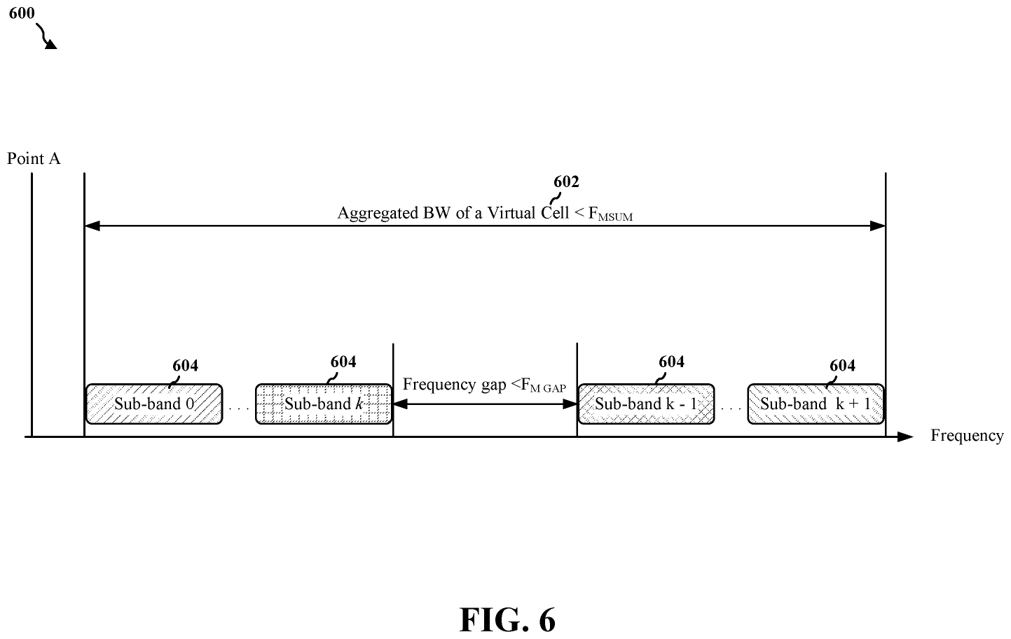

FIG. 6 illustrates an example 600 of a virtual cell 602, which involves the aggregation of multiple frequency bands or sub-bands 604. A single cell may span multiple frequencies over a frequency range, and there may be a frequency gap between two adjacent sub-bands. In this example, all the sub-bands 604 in a single virtual cell are configured with the same subcarrier spacing and the same CP length. In this example, all sub-bands 604 in a single virtual cell also have the same timing (RTD and TTD). For example, the RTD for each sub-band is much less than the symbol length of the carrier. Moreover, the TTD is the same, or different by a small amount, for all the uplink transmissions of all the sub-bands. Additionally, the RPSD imbalance between the sub-bands 604 is less than a particular value. Thus, from the UE point of view, all the sub-bands 604 have similar characteristics, and the base station may transmit data in all the sub-bands 604 of a single virtual cell from the same location. Thus, using virtual cell 602, sub-bands 604 with different frequency ranges such as illustrated in FIG. 4 may be carrier aggregated, achieving total desired throughputs for 6G. Moreover, these sub-bands 604 may be configured using respective bandwidth part (BWP) configurations in either a paired or unpaired spectrum.

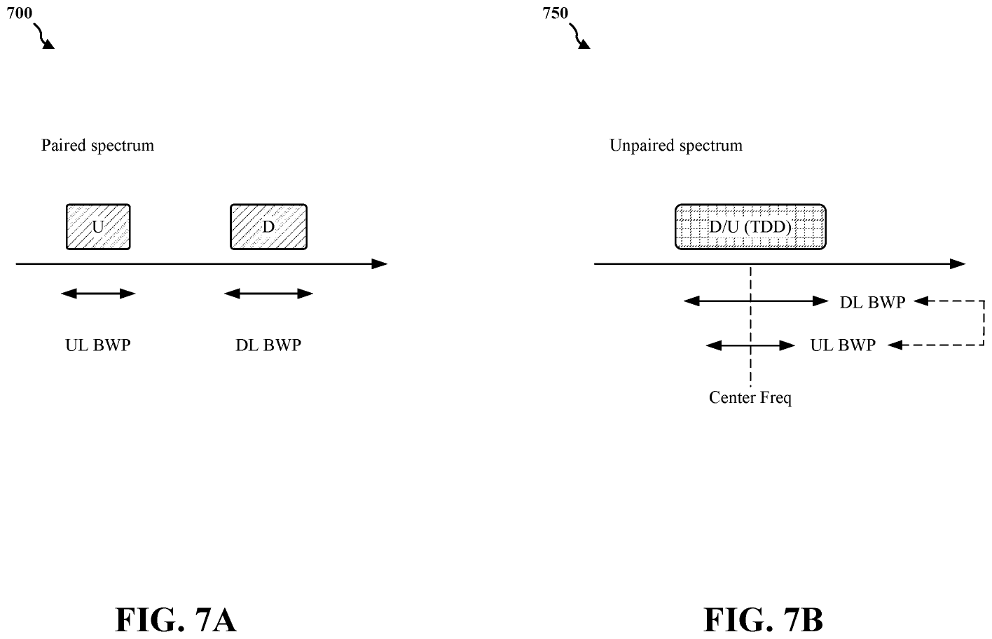

FIGS. 7A-7B illustrate examples 700, 750 of BWP configurations in the paired and unpaired spectrum, respectively. In 5G/NR, there may be one active downlink/uplink (DL/UL) BWP configured per cell, which may be switched over time by network signaling or a timer. That is, one bandwidth part may be active at a time, and each cell may be configured with a BWP configuration. Each BWP configuration includes parameters such as a subcarrier spacing and a CP length. Thus, the numerology is in general configured per BWP. For each downlink bandwidth part or uplink bandwidth part, the following parameters may be provided for the serving cell: subcarrier spacing, CP lengths, and resource block-related aspects. Based on the bandwidth part, the UE may ascertain the frequency of the carrier, subcarrier spacing, and the cyclic prefix. For instance, once a particular bandwidth part is activated for the boundaries, the UE may determine the subcarrier spacing, CP lengths, and the bandwidth. Based on this information, the UE may communicate with the base station.

In a given BWP configuration for each DL BWP or UL BWP, the UE may be provided with several parameters for the serving cell for paired spectrum operation. These parameters include: SCS, or the spacing between subcarriers in a channel; CP, which is used to prevent inter-symbol interference; and a common Resource Block (RB), which is defined by a start point (N_{BWP}^{start}) and a number of contiguous RBs (N_{BWP}^{size}). The start point may be calculated as Ocₐᵣᵣᵢₑᵣ+RBₛₜₐᵣₜ, where Ocₐᵣᵣᵢₑᵣ is an offset provided by a parameter offsetToCarrier for the SCS, and RBₛₜₐᵣₜ is an offset indicated by the parameter locationAndBandwidth. The number of contiguous RBs may be provided by the parameter locationAndBandwidth as a Resource Indication Value (RIV), setting N_{BWP}^{size}=275. These parameters further include an index in the set of DL BWPs or UL BWPs, which is provided by the respective parameter BWP-Id; and a set of BWP-common and a set of BWP-dedicated parameters, which may be provided by configurations BWP-DownlinkCommon and BWP-DownlinkDedicated for the DL BWP, or BWP-UplinkCommon and BWP-UplinkDedicated for the UL BWP. As for unpaired spectrum operation, a DL BWP may be linked with an UL BWP when the DL BWP index and the UL BWP index are the same. Thus, in situations where the spectrum is not paired (e.g., separate frequencies are not used for DL and UL), the DL and UL BWPs may be linked if they have the same index. Moreover, a UE does not expect to receive a configuration where the center frequency for a DL BWP is different than the center frequency for an UL BWP when the BWP-Id of the DL BWP is the same as the BWP-Id of the UL BWP. Thus, if the DL and UL BWPs have the same index, the UE expects them to have the same center frequency in unpaired spectrums.

In 5G/NR, there are some cases where different numerologies may configured for a given cell. In one example, different numerologies may be configured for the Synchronization Signal Block/Random Access Channel (SSB/RACH) compared to other channels/signals of a serving cell. For instance, SSB and RACH, which may be used for initial access or random access and not for data communications, may have different numerologies than other channels. For example, in FR2, the SSB may use 240 kHz SCS while other DL/UL channels/signals use 120 kHz SCS. In another example, different numerologies may be configured for different BWP configurations of a serving cell, such as the BWP configuration examples of FIGS. 7A-7B. For example, a UE may be configured with one BWP with 30 kHz SCS and another BWP with 60 kHz SCS, with one of them being activated at a time. In another example, the DL reception and UL transmission of a serving cell may be associated with different numerologies. For instance, regular DL/UL carriers may use 30 kHz SCS while a supplemental UL carrier may use 15 kHz SCS. In another example, different numerologies may be configured for respective serving cells in CA. For example, in the case of CA, different numerologies may be configured across different carriers or different cells for a given UE configured with CA. For instance, in Frequency Division Duplex-Time Division Duplex (FDD-TDD) CA, an FDD cell might use 15 kHz SCS while a TDD cell might use 30 KHz SCS.

However, notwithstanding the aforementioned special cases, different subcarrier spacings are not currently configured for general data/shared channels or control channels of a given bandwidth part, namely, Physical Downlink Control Channel (PDCCH), Physical Downlink Shared Channel (PDSCH), Physical Uplink Shared Channel (PUSCH), and Physical Uplink Control Channel (PUCCH). For instance, in a given cell, the data and control channels are configured with one numerology and subcarrier spacing associated with a given BWP configuration. Although a change of numerology for these channels may be applied by Downlink Control Information (DCI)/timer-based BWP-switching or Radio Resource Control (RRC) reconfiguration, for a given PDCCH, PUCCH, PDSCH, or PUSCH, in an active BWP, a single numerology is still being applied overall while the BWP is active. This restriction may not be conducive to achieving dynamic spectrum sharing using CA across different frequency ranges for increased throughputs in 6G as described with respect to FIG. 4, since the different frequency ranges (e.g., FR1, FR2, FR3) may be associated with different numerologies. Moreover, while virtual cells 602 may be configured with multiple non-contiguous sub-bands as illustrated in FIGS. 5 and 6, a similar restriction for these sub-bands is currently in place in that these sub-bands are to have a same numerology for similar reasons. Therefore, re-defining the BWP configurations of FIGS. 7A-7B, or otherwise providing configurations for control channels and data channels to handle different sub-band numerologies, would be helpful to lift this condition such that the sub-bands of a virtual cell may also correspondingly have different numerologies (e.g., SCS or CP lengths) and facilitate dynamic spectrum sharing with CA.

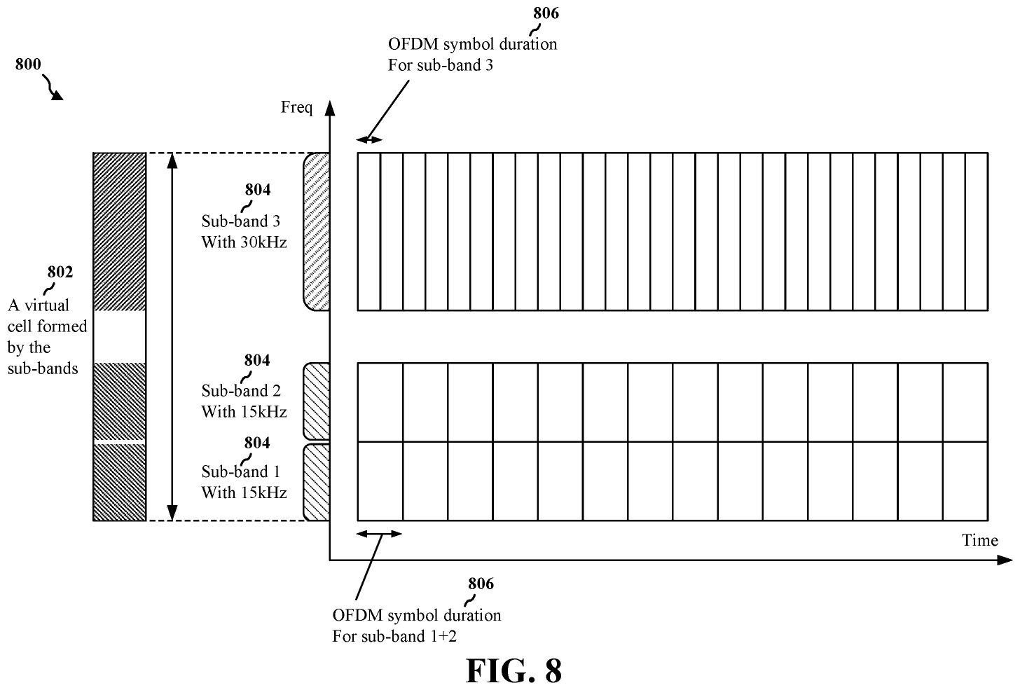

FIG. 8 illustrates an example 800 of a configuration of a virtual cell 802 (e.g., corresponding to virtual cell 602) formed by sub-bands 804 with different numerologies 806. In this given virtual cell, there are three sub-bands, although there can be other numbers of sub-bands in other examples. For instance, in the illustrated example, the UE may receive a virtual cell configuration indicating the cell is formed by three sub-bands. Sub-bands 1 and 2 may be configured with 15 kHz SCS, and sub-band 3 may be configured with 30 kHz SCS, although the SCSs may be different in other examples. These different numerologies across the sub-bands are evident when looking at the time-frequency grids illustrated in FIG. 8. For instance, sub-bands 1 and 2 may have a longer OFDM symbol duration compared to sub-band 3 because their subcarrier spacing is lower. Conversely, sub-band 3 may have a shorter OFDM symbol duration compared to sub-bands 1 and 2.

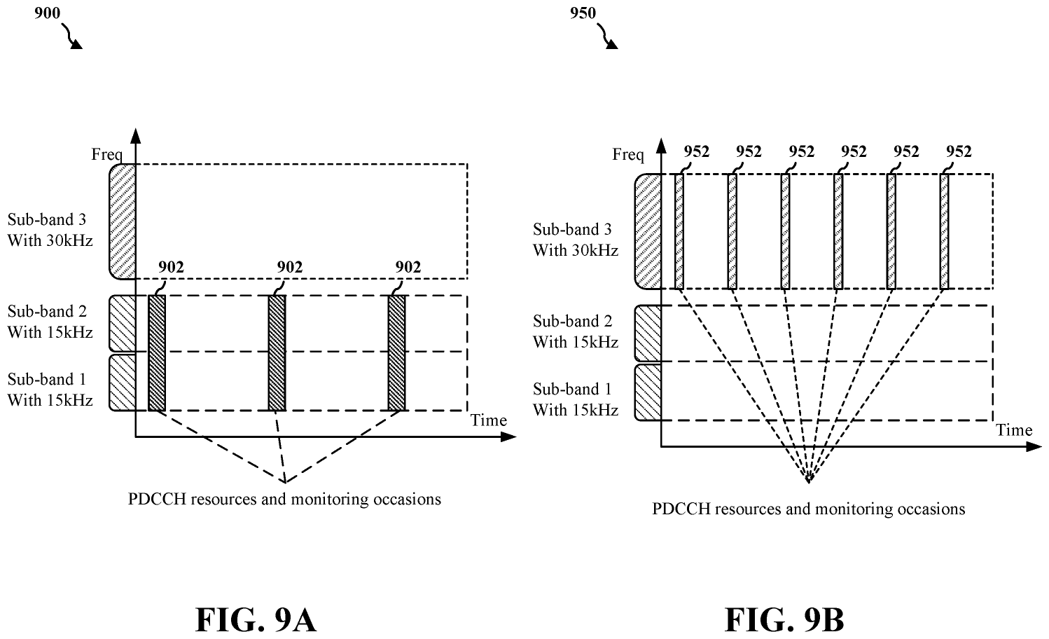

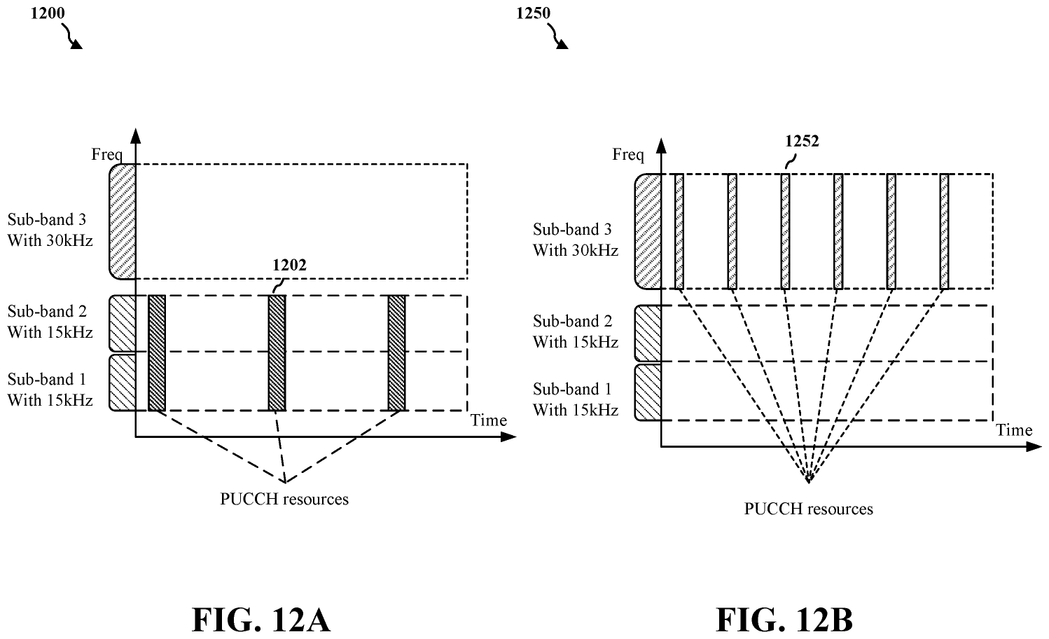

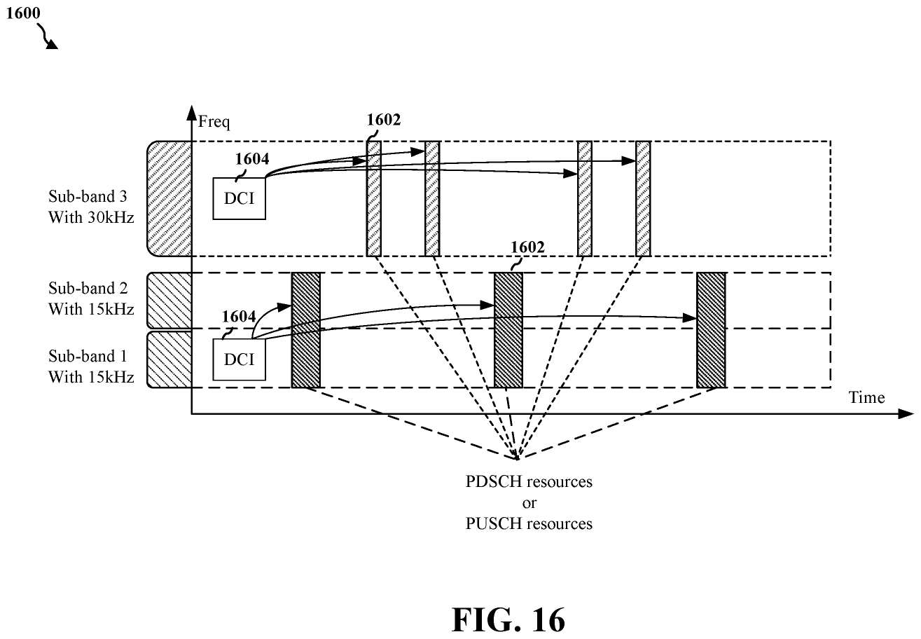

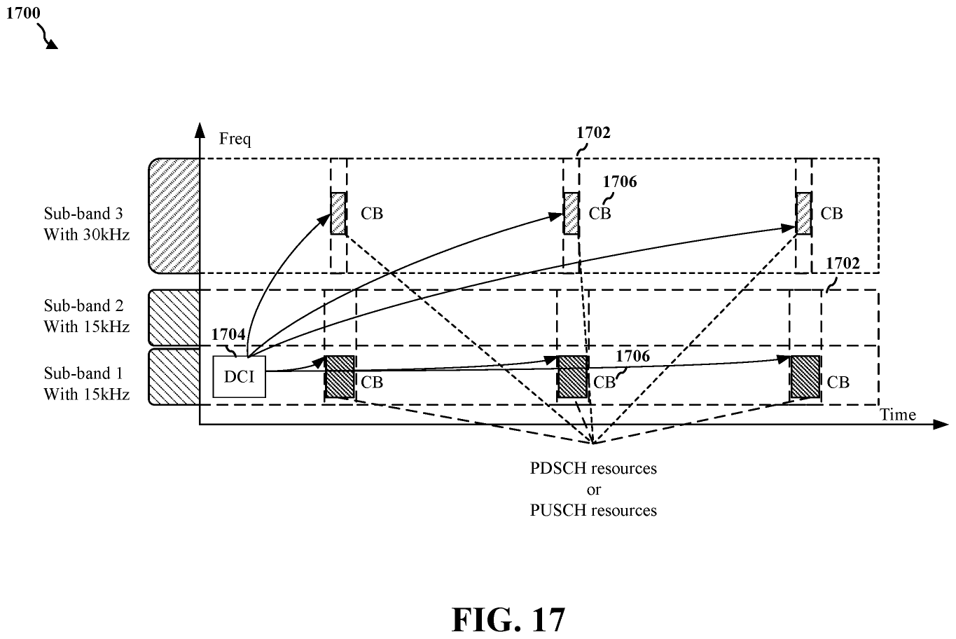

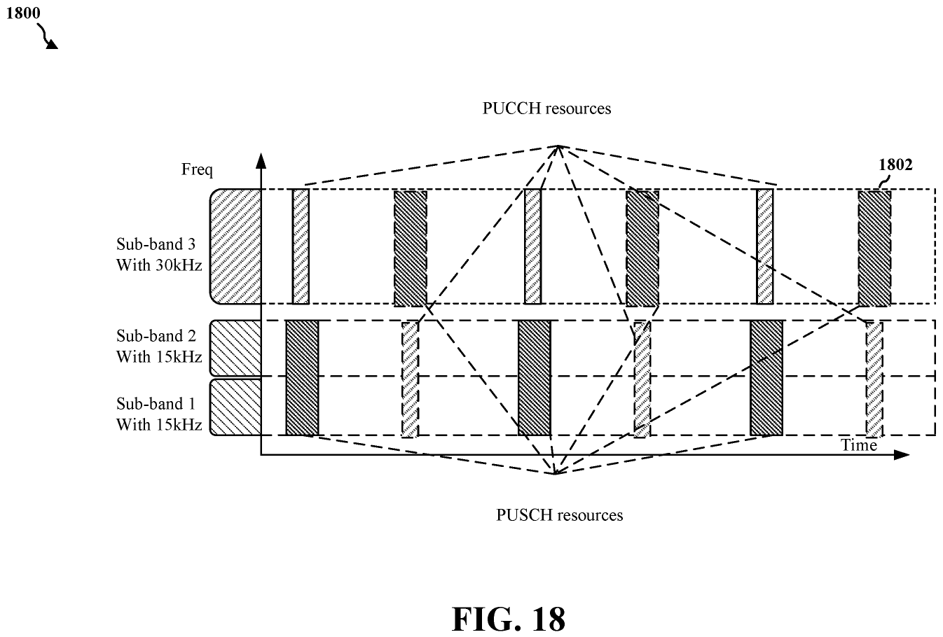

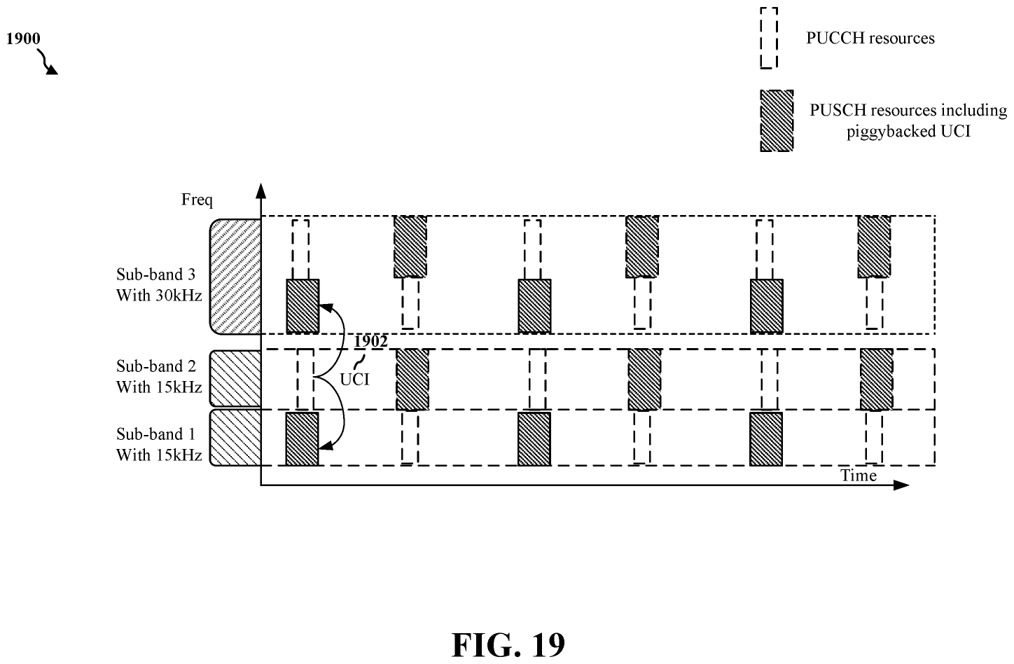

To achieve such single virtual cells 802 and apply them for dynamic spectrum sharing with CA, aspects of the present disclosure provide configurations of control channels including PDCCH and PUCCH and data channels including PDSCH and PUSCH that accommodate multiple non-contiguous, sub-bands 604, 804 (e.g., frequency ranges 402, 404, 406 or carriers 504, 506) with different numerologies 806 constituting different subcarrier spacings or different CP lengths. In particular, FIGS. 9A-9B, 10, and 11A-11C illustratively describe different examples of a virtual cell in 6G that contains multiple sub-bands with different numerologies and which focuses on the handling of PDCCH. These examples allow for different numerologies for PDCCH across sub-bands for the virtual cell by providing configurations for how the PDCCH may be mapped and how the UE may monitor the PDCCH in this case. Moreover, FIGS. 12A-12B, 13, 14, and 15A-15B illustratively describe different examples pertaining to PUCCH for virtual cells with different numerologies. Furthermore, FIGS. 16 and 17 illustratively describe different examples pertaining to the data channels for virtual cells with different numerologies, including PDSCH and PUSCH. Finally, FIGS. 18 and 19 illustratively describe different examples pertaining to concurrent PUCCH and PUSCH for virtual cells with different sub-bands and different numerologies, where concurrent here refers to at least one symbol of the PUCCH overlapping with at least one symbol of the PUSCH.

FIGS. 9A-9B illustratively describe examples 900, 950 of configurations of a virtual cell 802 that contains multiple sub-bands 804 with different numerologies 806 and includes PDCCH. In these examples, for a virtual cell with different sub-bands with different numerologies, the UE 104 may be semi-statically configured to monitor the PDCCH on one or multiple sub-bands with a same numerology of the virtual cell. Thus, even though the virtual cell has multiple sub-bands with different numerologies, the UE is configured to monitor the PDCCH on sub-bands that have the same numerology.

Referring to the illustrated examples 900, 950, a single virtual cell may have multiple sub-bands with two different numerologies. For a given virtual cell that spans across several frequencies such as illustrated in these examples, the UE may be configured to monitor the PDCCH that is mapped on one or multiple sub-bands with the same numerology. Thus, the PDCCH may be mapped across sub-bands over the virtual cell having the same numerology. The UE may be configured to periodically monitor the PDCCH in the given numerology. In the example of FIG. 9A, the monitoring may be for instance with the 15 kHz subcarrier spacing, while in the example of FIG. 9B, the monitoring may be for instance with the 30 kHz subcarrier spacing. Thus, although the virtual cell contains multiple numerologies, the PDCCH monitoring here does not involve handling multiple numerologies. Here, the UE is semi-statically configured to monitor the PDCCH on one or multiple sub-bands with one numerology, even though the virtual cell has different numerologies. As a result, in these examples, the UE may not monitor PDCCH with different numerologies at a given time period 902, 952. Thus, even though the UE has the capability to monitor PDCCH on sub-bands with different numerologies, it only monitors PDCCH with a specific numerology at any given time period 902, 952.

The configuration of FIGS. 9A-9B may indicate how the UE may monitor the PDCCH in a virtual cell with different numerologies for sub-bands. For instance, the configuration may provide a number of blind decodes, denoted as B, and a number of non-overlapped Control Channel Elements (CCEs), denoted as C, for PDCCH monitoring in a certain time period for the cell (e.g., PDCCH monitoring occasion, per slot, per sub-frame or per other example of time period 902, 952). These two parameters, B and C, may define the processing capability for the UE. Here, the UE may monitor PDCCH using blind decodes, but due to processing capability limitations, the UE may not monitor an unlimited number of PDCCH candidates. Therefore, the number of blind decodes at a time may be limited for the UE. For example, in a slot, the UE may be configured to monitor up to 44 blind decoding candidates and 56 CCEs for PDCCH monitoring, or other quantities in other examples. Here, the quantities of B blind decodes and C CCEs to be monitored by the UE during PDCCH monitoring in a certain time period for the cell may be configured by RRC signaling or pre-defined. Furthermore, B and C may be limited by maximum numbers B_{max,μ}, C_{max,μ} for the given numerologies, where u denotes the numerology index (e.g., SCS=2^{μ} kHz). Different numerologies may have different maximum numbers of blind decodes and CCEs, and these may be pre-defined or reported by UE capability. Thus here, the UE may be configured to monitor PDCCH at the time periods illustrated in FIG. 9A or 9B, and at each monitoring occasion or time period 902, 952, the number of blind decodes or CCEs for PDCCH monitoring may be defined to not exceed those numbers due to UE capability limitations.

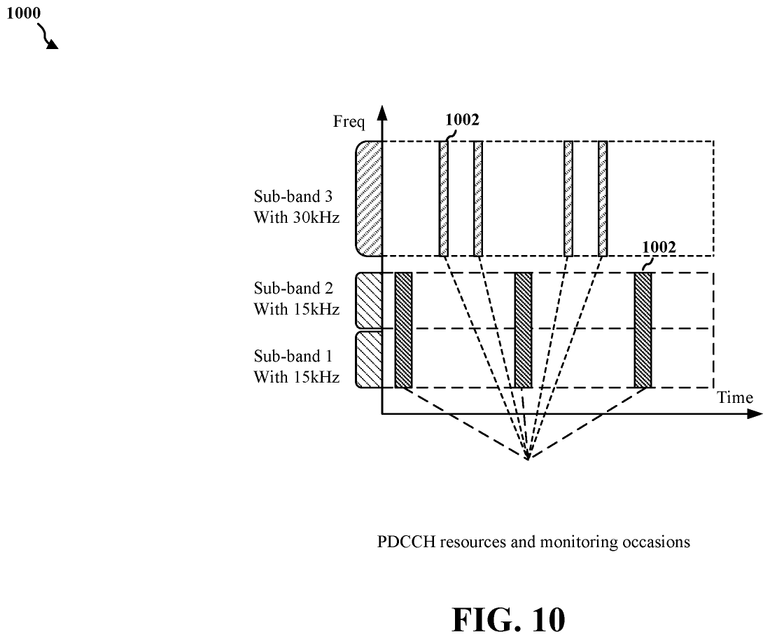

FIG. 10 illustrate another example 1000 of a configuration of virtual cell 802 with different numerologies 806 for sub-bands 804 including PDCCH. In this example, for a virtual cell with different sub-bands with different numerologies, the UE 104 may be configured to monitor the PDCCH on one or multiple sub-bands with more than one numerology. However, the UE may be configured to monitor the PDCCH with one numerology at a given time period 1002, such as per PDCCH monitoring occasion, slot, or sub-frame. Thus, while the UE may have the capability to monitor PDCCH on sub-bands with different numerologies, the UE may only monitor PDCCH with a specific numerology at any given time. This approach allows the UE to adapt to the different numerologies present in the virtual cell, but in a time-divided manner, focusing on one numerology at a time.

Referring to the illustrated example 1000, a virtual cell may span multiple sub-bands with two or more different numerologies. At a given time, the UE may monitor the PDCCH with a specific numerology. For instance, the UE may monitor the PDCCH that spans sub-band 1 and sub-band 2, both of which have the same numerology. However, the UE does not monitor the PDCCH in sub-band 3, which has a different numerology. At a different time location, the UE may monitor the PDCCH with another numerology. For example, the UE may monitor the PDCCH in sub-band 3 with a 30 kHz subcarrier spacing. However, when the UE monitors the PDCCH in sub-band 3, the UE does not monitor the PDCCH on sub-band 1 or sub-band 2, which have a different numerology. Thus, the UE may monitor different numerologies in a Time Division Multiplexing (TDM) manner, but at any given time period 1002, the UE only monitors one numerology. This approach allows the UE to adapt to the different numerologies present in the virtual cell in a time-divided manner, focusing on one numerology at a time. As a result, in this example, the UE may not monitor PDCCH with different numerologies at a given time. Thus, even though the UE has the capability to monitor PDCCH on sub-bands with different numerologies, it only monitors PDCCH with a specific numerology at any given time.

Similarly, the configuration of FIG. 10 may indicate a number of blind decodes, denoted as B, and the number of non-overlapped CCEs, denoted as C, for PDCCH monitoring in a certain time period for the cell (e.g., PDCCH monitoring occasion, per slot, per sub-frame or other time period 1002). These parameters, B and C, may be configured by RRC signaling or pre-defined. However, the maximum number of B and C, B_{max,μ}, C_{max,μ}, may be different for different numerologies, where u denotes the numerology index (e.g., SCS=2^{μ} kHz). For example, for a 15 kHz subcarrier spacing, one set of B and C maximums may be defined, and for a 30 kHz spacing, another set of B and C maximums may be defined. Thus, the limits may be different across different monitoring occasions with different numerologies. For example, for the first subcarrier spacing (15 kHz), the UE may be able to monitor up to 44 candidates at a given time. However, if the UE is configured to monitor the PDCCH with a 30 kHz subcarrier spacing, it may monitor up to 56 candidates at a given time. Thus, because the UE performs TDM monitoring of PDCCH with different numerologies, the UE may monitor up to 44 candidates in one time period and up to 56 candidates in another time period. These maximum numbers may be different in other examples depending on which numerology the UE monitors the PDCCH candidates at a given time.

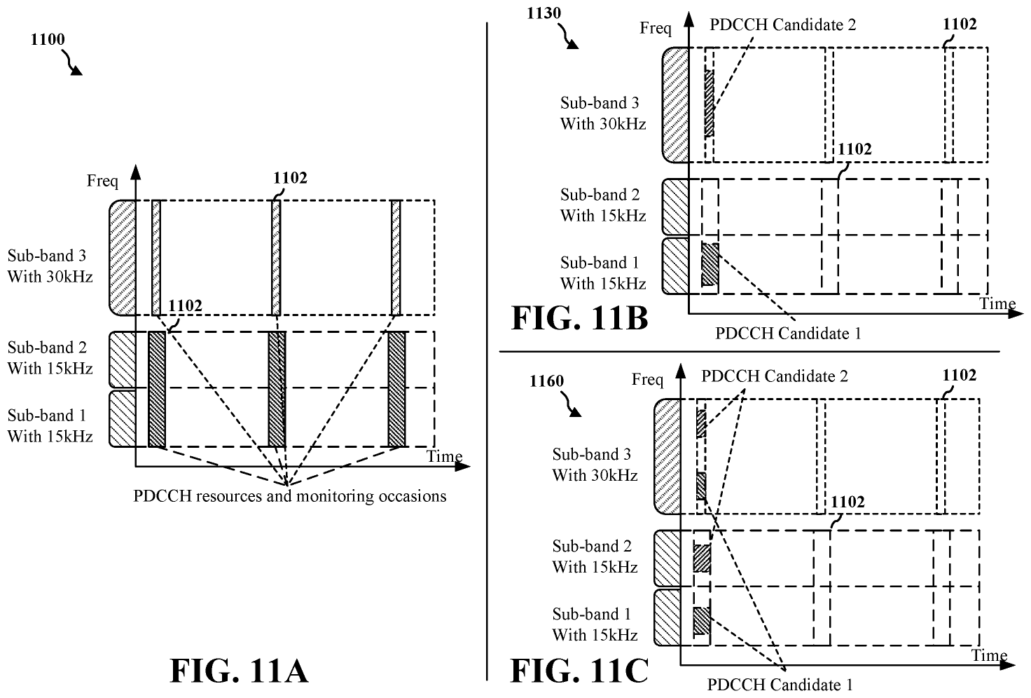

FIGS. 11A-11C illustrate other examples 1100, 1130, 1160 of an aspect for handling the PDCCH in a configuration of a virtual cell 802 with different numerologies 806 for sub-bands 804. In this aspect, as illustrated in FIG. 11A, for a virtual cell with different sub-bands with different numerologies, the UE may be configured to monitor the PDCCH on one or multiple sub-bands with more than one numerology at a given time period 1102 (e.g., per PDCCH monitoring occasion, slot, sub-frame). The aspect may be realized with different examples. In one example 1130, as illustrated in FIG. 11B, the CCEs of a PDCCH candidate may be mapped on resources with a single given numerology. Thus, all the CCEs of a PDCCH candidate may be associated with the same numerology. In another example 1160, as illustrated in FIG. 11C, the CCEs of a PDCCH candidate may be mapped on resources with multiple numerologies. Thus, the CCEs of a PDCCH candidate may be associated with different numerologies. This approach allows for more flexibility than the example of FIG. 11B in how the UE monitors the PDCCH in a virtual cell with different numerologies.

Referring to the example 1130 of FIG. 11B, in this approach, the CCEs of a PDCCH candidate may be mapped on resources with a given numerology. Thus, the resources of each PDCCH candidate do not span across multiple numerologies. They may span across multiple sub-bands, but still within the given numerologies. Here, a particular PDCCH candidate may be mapped to the resources with a given numerology over the virtual cell. For example, PDCCH candidate 1 may be mapped to resources with one numerology, and PDCCH candidate 2 may be mapped to other resources with a different numerology. Each candidate may have a single numerology and does not span across multiple numerologies. Thus, when the UE monitors PDCCH candidate 1, it does not monitor the PDCCH candidate that spans resources with different numerologies at a given time. This makes the decoding complexity much simpler than the example of FIG. 11C, because the UE does not consider the resources across different numerologies to monitor a given PDCCH candidate. Candidate 1 and candidate 2 may be processed completely independently.

In the example of FIG. 11B, the number of blind decodes, denoted as B, and the number of non-overlapped CCEs, denoted as C, for PDCCH monitoring in a certain time period for the cell (e.g., PDCCH monitoring occasion, per slot, per sub-frame or other time period 1102) for each numerology may be configured by RRC signaling or pre-defined. Moreover, B and C for PDCCH monitoring in a time period for the cell for each numerology may be limited by maximum numbers for the numerology, B_{max,μ}, C_{max,μ}. These limits may be pre-defined or reported by UE capability, where u denotes the numerology index (e.g., SCS=2^{μ} kHz) for the PDCCH at each time period. The UE may have a maximum number of blind decodes, B, and maximum number of CCEs, C, to process as a limitation for PDCCH monitoring at a given time period for the cell. B and C may be defined for each numerology, and for each numerology, B_{max,μ} and C_{max,μ} may be defined, where the UE monitors up to B_{max,μ}, C_{max,μ} for the given numerology of the given virtual cell. For example, the number of candidates for 15 kHz spacing may be up to 44, and the number of candidates for the 30 kHz can be up to 56 at a given time. Alternatively, the number of candidates may be different in these and other examples.

Referring to the example 1160 of FIG. 11C, the CCEs of a PDCCH candidate may be mapped on resources with different numerologies. Thus, the resources of each PDCCH candidate may span across multiple numerologies. Here, for a given PDCCH candidate, it may be split into the resources with different numerologies. For example, one candidate may have resources mapped to resources with different numerologies, and another candidate could have additional resources that span across different numerologies. Thus, the UE may process a given candidate across different numerologies, which requires a higher processing capability than the example of FIG. 11B. However, in this example, a candidate may be mapped across sub-bands with different numerologies, and thus more frequency diversity gain may be achievable in the example of FIG. 11C than in the example of FIG. 11B. The PDCCH may split across many frequencies with different numerologies in this example.

In this example of FIG. 11C, the number of blind decodes, denoted as B, and the number of non-overlapped CCEs, denoted as C, for PDCCH monitoring in a certain time period for the cell (e.g., PDCCH monitoring occasion, per slot, per sub-frame) for a set of numerologies for the PDCCH may be configured by RRC signaling or pre-defined. Moreover, B and C for PDCCH monitoring in a time period for the cell for the set of numerologies for the PDCCH may be limited by maximum numbers for the numerology, B_{max,μ_ref}, C_{max,μ_ref}. These limits may be pre-defined or reported by UE capability, where μ_ref denotes a reference numerology (e.g., a maximum SCS or a minimum SCS of the set of numerologies) for the PDCCH at each time period of the set of numerologies. A reference numerology is considered here, unlike in the examples of FIGS. 9A, 9B, and 10, since for a given candidate, it spans multiple numerologies. Therefore, B_{max,μ_ref} and C_{max,μ_ref} may not be defined for a given particular numerology as in the prior example since the candidate is spread over multiple numerologies. Thus, in the example of FIG. 11C, the B_{max,μ_ref}, C_{max,μ_ref} may be defined for the given different numerologies. For example, in a case where a PDCCH candidate spans across sub-bands with 15 kHz and 30 kHz subcarrier spacing, a different numerology may be defined for the candidates. The reference numerology may be the maximum subcarrier spacing or minimum subcarrier spacing of the set of numerologies for the PDCCH set. If the minimum subcarrier spacing is 15 kHz, then the B_{max,μ_ref}, C_{max,μ_ref} may be defined for 15 kHz for example to limit the processing capability for PDCCH monitoring for the candidate that spans 15 kHz and 30 kHz. This concept of different numerologies may thus increase the complexity for PDCCH monitoring compared to prior examples.

FIGS. 12A and 12B illustrate examples 1200, 1250 of a configuration of virtual cell 802 with different sub-bands 804 and different numerologies 806 in which the UE may handle PUCCH. In these examples, the UE may be configured with N PUCCH resources. Each PUCCH resource 1202, 1252 may be formed by one or multiple time-frequency resources in sub-band(s) with one numerology. All the N PUCCH resources may be configured with the sub-band(s) with one numerology.

Referring to the illustrated examples 1200, 1250, for a given virtual cell with different sub-bands with different numerologies, the UE 104 may be configured with one or more resources where each PUCCH resource 1202, 1252 is formed by one or multiple time-frequency resources in a sub-band, but with a single numerology. For example, the UE may be configured with three PUCCH resources in FIG. 12A, six PUCCH resources in FIG. 12B, or other numbers of PUCCH resources in other examples, where each PUCCH resource is confined within the sub-bands of a single numerology. The UE or network then selects the UE to transmit the PUCCH on one of these PUCCH resources. At a given transmission occasion of the PUCCH, the UE does not transmit the PUCCH with different numerologies. Each time the UE transmits the PUCCH using one of the resources, the UE transmits based on a single numerology.

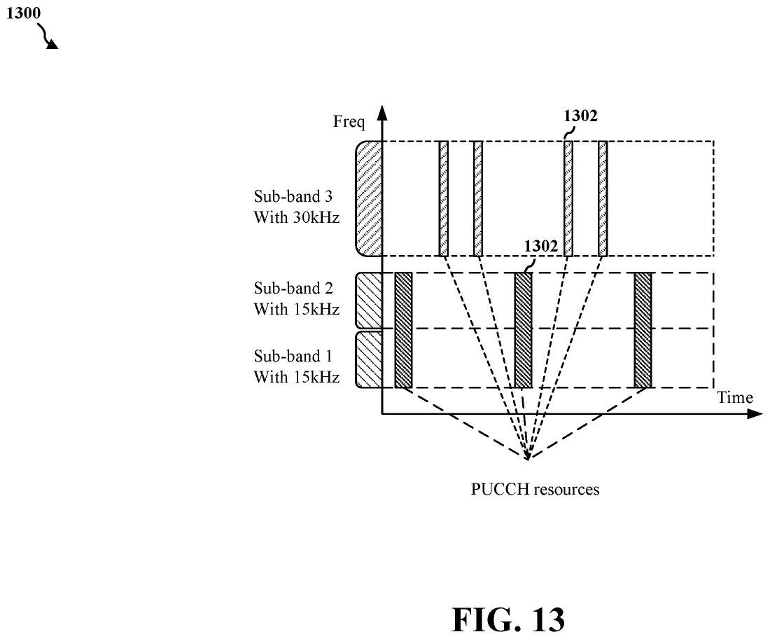

FIG. 13 illustrates an example 1300 of a configuration of virtual cell 802 with different sub-bands 804 and different numerologies 806 in which the UE may handle PUCCH. In this example, the UE 104 may be configured with N PUCCH resources, where each PUCCH resource is formed by one or multiple time-frequency resources in sub-band(s) with one numerology. However, some of N PUCCH resources may be configured with the sub-band(s) with one numerology and the other PUCCH resources are configured with the sub-band(s) with another numerology. More particularly, in the example of FIG. 13, a UE may transmit a PUCCH on one of the numerologies at a given time period 1302.

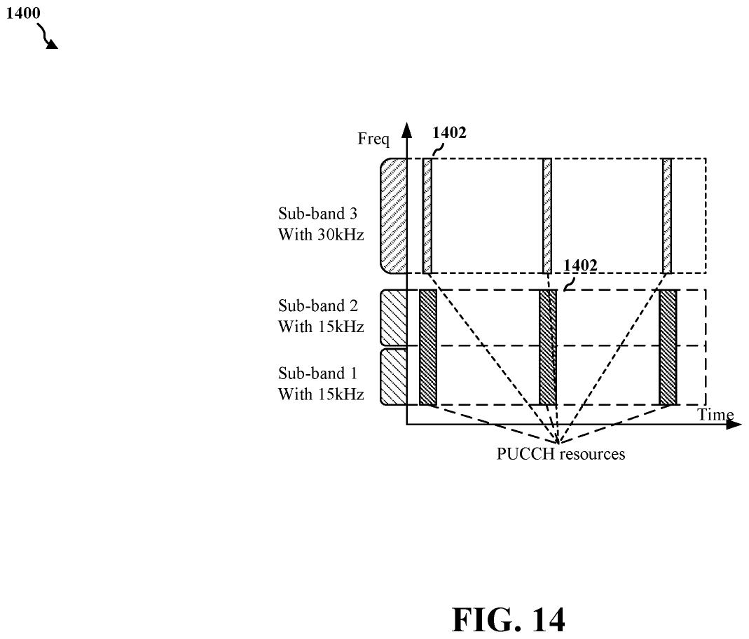

FIG. 14 illustrates another example 1400 of a configuration of virtual cell 802 with different sub-bands 804 and different numerologies 806 in which the UE may handle PUCCH. In this example, the UE may be configured with N PUCCH resources, where each PUCCH resource is formed by one or multiple time-frequency resources in sub-band(s) with one numerology, similar to FIG. 13. However, some of N PUCCH resources may be configured with the sub-band(s) with one numerology and the other PUCCH resources may be configured with the sub-band(s) with another numerology. More particularly, in the example of FIG. 14, a UE may transmit multiple PUCCHs on multiple numerologies at a given time period 1402 simultaneously. In the example of FIG. 14, the multiple PUCCHs in the given time period may carry different uplink control information, enabling large payload feedback, or they may carry the same uplink control information, enabling frequency diversity. However, in these examples, a single PUCCH resource may always be associated with a single numerology, even if it spans multiple sub-bands with different numerologies. Thus, while multiple transmissions may involve different numerologies, each individual PUCCH resource may always be tied to one numerology.

Referring to the illustrated examples 1300, 1400, similar to the examples of FIGS. 12A-12B, each PUCCH resource may be associated with a single numerology. However, different PUCCH resources may have different numerologies. Some of the PUCCH resources may be configured with the sub-band with one numerology, and other PUCCH resources may be configured with another numerology. There may be multiple numerologies involved for PUCCH transmission, but at a given time for one PUCCH transmission, the numerology may be singular. Thus, even though the UE may have the capability to transmit PUCCH on sub-bands with different numerologies, the UE may transmit PUCCH with a specific numerology at any given time. This is similar to a TDM model in FIG. 13 or a FDM model in FIG. 14.

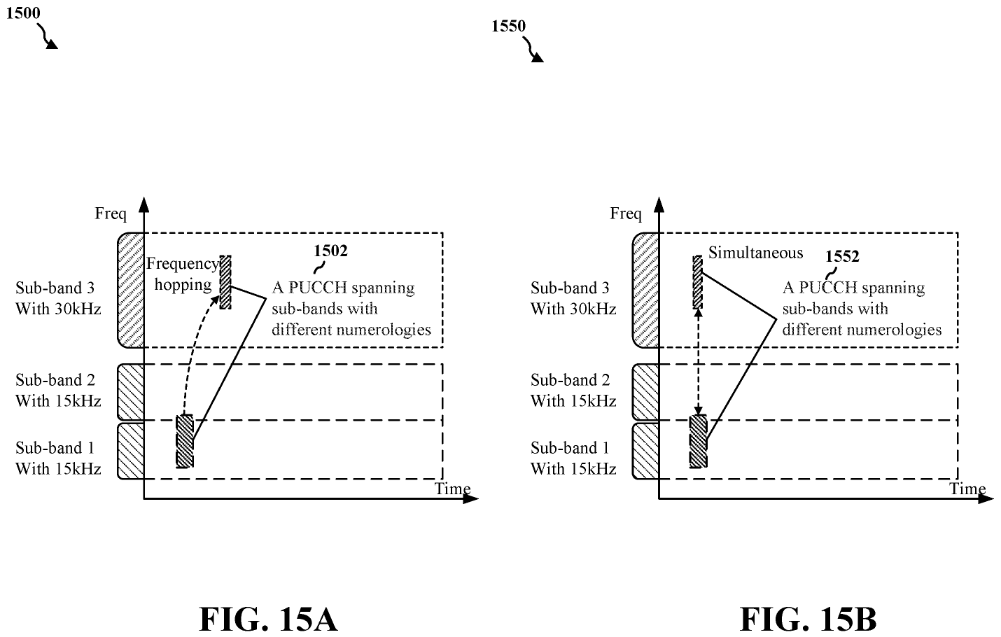

FIGS. 15A-15B illustrate examples 1500, 1550 of configurations pertaining to PUCCH for virtual cells 802 with different sub-bands 804 and different numerologies 806. In these examples, the UE may be configured with N PUCCH resources 1502, 1552. However, unlike the examples of FIGS. 13 and 14, here each PUCCH resource 1502, 1552 may be formed by one or multiple time-frequency resources in sub-band(s) with multiple numerologies.

In particular, FIG. 15A illustrates one example 1500 where different numerologies for resources of PUCCH resource 1502 may be in the time-domain. For instance, a first half of time-domain resources of PUCCH resource 1502 may be with numerology 1, and the second half of time-domain resources of the same PUCCH resource may be with numerology 2. Thus, in this example, a PUCCH resource may be formed by two resource chunks with different numerologies, which are transmitted in a frequency hopping manner. This is done to achieve frequency diversity gain across different sub-bands with different numerologies.

Alternatively, FIG. 15B illustrates another example 1550 where different numerologies for resources of a PUCCH format may be in the frequency-domain. This approach allows for simultaneous transmission, which can provide the same frequency diversity gain as the example of FIG. 15A because it spans the same frequencies. However, compared to the example of FIG. 15A, the example of FIG. 15B may be more complex since the UE transmits each portion of the PUCCH resource 1552 simultaneously at a given time using multiple sub-bands with different numerologies. This results in a shorter delay for PUCCH transmission compared to the example of FIG. 15A, but it leads to the transmission power being split between the two resource chunks. In contrast, in the example of FIG. 15A, the UE does not split the transmission power because at a given time, since the UE may transmit either one part or the other. This allows each transmission to get full power, although at a slight delay compared to FIG. 15B. However, either example in FIGS. 15A-15B allows the UE to achieve either frequency-diversity gain or payload/capacity increase, similar to the example of FIG. 14.

FIG. 16 illustrates an example 1600 of a configuration of a PDSCH or PUSCH for virtual cells 802 with different numerologies 806. In this example, for a virtual cell with different sub-bands 804 and different numerologies, the UE may receive a PDSCH or transmit a PUSCH on one or multiple sub-bands with one numerology. PDSCHs or PUSCHs in different time periods 1602 (e.g., slot, sub-frame) may be on different sub-bands with different numerologies. A scheduler such as DCI 1604 may ensure that a PDSCH or PUSCH is scheduled or mapped on sub-band(s) with the same numerology in the virtual cell. Depending on the numerology where PDSCH or PUSCH is scheduled, the DCI fields or bits may be interpreted in different ways. For example, if a UE detects DCI 1604 scheduling a PDSCH or PUSCH on sub-band(s) of a numerology, the DCI bits may be interpreted such that the DCI fields are optimal for the sub-band(s) of that numerology (e.g., MCS, TPMI, TDRA, etc. are configured for a numerology and those for another numerology may be different).

FIG. 17 illustrates another example 1700 of a configuration of a PDSCH or PUSCH for virtual cells 802 with different numerologies 806. In this example, for a virtual cell with different sub-bands 804 with different numerologies, the UE may receive a PDSCH or transmit a PUSCH on one or multiple sub-bands with more than one numerology, such as simultaneously at a given time 1702. A PDSCH or PUSCH may be scheduled or mapped on sub-bands with different numerologies, for example via DCI 1704. Codeblocks 1706 (CBs) of a data or transport block may be mapped on time-frequency resources such that a CB does not span sub-band(s) with different numerologies.

FIG. 18 illustrates an example 1800 of a configuration of a concurrent PUCCH and PUSCH for virtual cells 802 with different sub-bands 804 and different numerologies 806. In this example, for a virtual cell with different sub-bands and different numerologies, the UE may transmit a PUCCH on one or multiple sub-bands with one or multiple numerologies, and a PUSCH on different one or multiple sub-bands with one or multiple numerologies. This approach allows for simultaneous PUCCH and PUSCH transmissions on different sub-bands of a virtual cell at a given time period 1802.

FIG. 19 illustrates another example 1900 of a configuration of a concurrent PUCCH and PUSCH for virtual cells 802 with different sub-bands 804 and different numerologies 806. In this example, for a virtual cell with different sub-bands with different numerologies, the UE 104 may transmit a PUSCH on one or multiple sub-bands with one or multiple numerologies, where uplink control information (UCI 1902) of a concurrent PUCCH is piggybacked on the PUSCH. In one approach, the UCI 1902 may be multiplexed on the PUSCH on one or multiple sub-bands with a certain numerology. This may be a reference numerology, such as the lowest SCS, highest SCS, or the same SCS as the PUCCH. In another approach, the UCI 1902 may be multiplexed on the PUSCH on one or multiple sub-bands with multiple numerologies. The UCI may be mapped on the same SCS(s) as PUCCH. Thus, these approaches, when the UE transmits the PUSCH, if there is UCI to transmit, then the UCI of a concurrent PUCCH may be piggybacked on the PUSCH. If the PUSCH spans multiple numerologies, the UCI may be mapped onto each part of the PUSCH with a given numerology. If the PUSCH does not span across multiple numerologies, the PUSCH may be piggybacked to one part of the PUSCH with a given numerology.

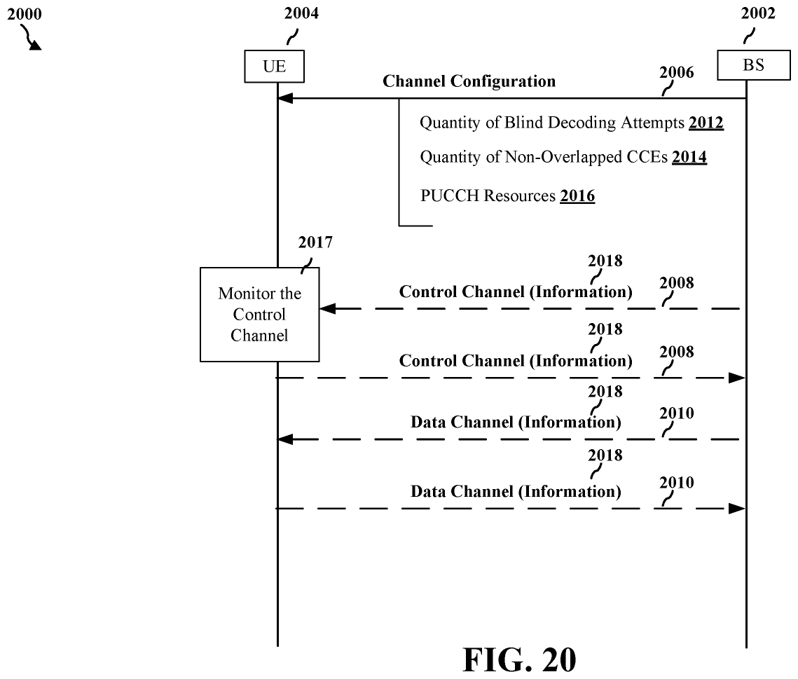

FIG. 20 illustrates an example 2000 of a call flow diagram between a base station 2002 and a UE 2004. Here, base station 2002 may correspond to base station 102, 310, and UE 2004 may correspond to UE 104, 350. Initially, the base station may send a channel configuration 2006 to the UE, and the UE may obtain the channel configuration 2006 from the base station. For example, to obtain the configuration 2006, the UE may receive a signal from the base station, demodulate the signal to extract the channel configuration information, and then process the information to ascertain the configuration of the control channel or data channel in the cell. This process may involve the UE's receive processor(s) 356 and controller(s)/processor(s) 359, which implement layer 1, layer 2, and layer 3 functionalities as described in FIG. 3. The channel configuration 2006 may be or include at least one of a PDCCH configuration, a PUCCH configuration, a PDSCH configuration, a PUSCH configuration, a BWP configuration, a virtual cell configuration, or other configuration. The channel configuration 2006 may indicate one or more parameters, resources, or other configuration information which the UE may apply to monitor, receive or transmit information in a control channel 2008, such as PDCCH or PUCCH, or in a data channel 2010, such as PDSCH or PUSCH. Moreover, for PDCCHs, the channel configuration may include a quantity of blind decoding attempts 2012 and a quantity of non-overlapped CCEs 2014. The quantity of blind decoding attempts may refer to B as described with respect to the preceding Figures. The quantity of non-overlapped CCEs may refer to C as described with respect to the preceding Figures. Furthermore, for PUCCHs, the channel configuration may include or indicate PUCCH resources 2016. The PUCCH resources may correspond to the PUCCH resources described with respect to the preceding Figures.

After obtaining the channel configuration 2006, depending on whether the configuration is for PDCCH, PUCCH, PDSCH, or PUSCH, the UE may perform a number of actions. In one example, for PDCCH, the UE may at block 2017 monitor the control channel according to the configured quantities of blind decoding attempts and non-overlapped CCEs, and the UE may receive the control channel (PDCCH) including information 2018 such as DCI. For example, the UE may first use its receive processor(s) 356 to demodulate the received signal. The UE may then extract the PDCCH information from the demodulated signal. This may involve performing blind decoding attempts in a specified quantity of non-overlapped CCEs. After the PDCCH information has been extracted, the UE may then process the information to recover the downlink control information. This processing may involve decoding the information based on the specific numerology associated with the sub-band in which the PDCCH was received.

In another example, for PUCCH, the UE may transmit the control channel (PUCCH) including information 2018 such as UCI. For example, the UE may use its transmit processor(s) 368 to encode the uplink control information, modulate the encoded information onto a carrier signal, and then transmit the signal via its antennas 352. In a further example, for PDSCH, the UE may receive DCI scheduling the data channel (PDSCH), and the UE may receive information 2018 such as downlink data in the PDSCH. For example, the UE may use its receive processor(s) 356 to demodulate the received signal, extract the PDSCH information, and then process the information to recover the downlink data. In an additional example, for PUSCH, the UE may receive DCI scheduling the data channel (PUSCH), and the UE may transmit information 2018 such as uplink data in the PUSCH. For example, the UE may use its transmit processor(s) 368 to encode the uplink data, modulate the encoded data onto a carrier signal, and then transmit the signal via its antennas 352.

The UE may receive or transmit the information 2018 in PDCCH, PUCCH, PDSCH, or PUSCH, in sub-bands 804 of virtual cell 802 with different numerologies 806 based on configuration 2006. For example, the UE may determine from channel configuration 2006 the given time periods (e.g., monitoring occasions, slots, or sub-frames) in which PDCCH resources or monitoring occasions, PUCCH resources, PDSCH resources, or PUSCH resources are configured or scheduled, as well as the time-frequency allocations of these resources in one or more of the sub-bands 804, such as illustrated in any of the examples described in the preceding Figures. The UE may also monitor PDCCH in determined PDCCH resources according to the configured quantities of blind decoding attempts and non-overlapped CCEs depending on the allocation example of the preceding Figure(s) which applies. After determining the resources and in some cases monitoring the PDCCH, the UE may receive information in PDCCH, PDSCH, or transmit information in PUCCH, PUSCH in the determined resources associated with the respective numerologies. For example, the UE may communicate in resources of only a single numerology, communicate in resources of multiple numerologies at different times, communicate in resources of multiple numerologies simultaneously, frequency hop from one numerology-associated sub-band to another for reception or transmission, or otherwise communicate with the base station in the sub-bands, carriers, or frequency ranges of the virtual cell depending on the allocation example of the preceding Figure(s) which applies. Thus, the UE may receive or transmit information in control channels or data channels with dynamic spectrum sharing using CA in a virtual cell having sub-bands of different numerologies, thereby achieving increased throughputs.

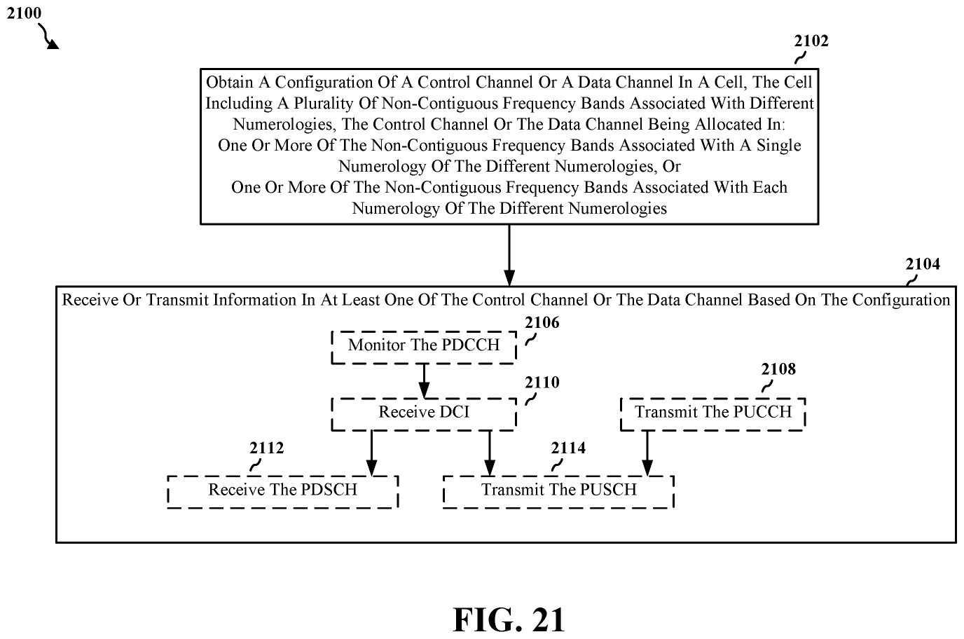

FIG. 21 is a flowchart 2100 of an example method or process for wireless communication. The method may be performed by a UE, such as the UE 104, 350, 2004, the apparatus 2202, or its components as described herein. The method allows a UE to receive or transmit information in control channels or data channels with dynamic spectrum sharing using CA in a virtual cell having sub-bands of different numerologies, thereby achieving increased throughputs such as those described with respect to FIG. 4.

At block 2102, the UE may obtain a configuration of a control channel or a data channel in a cell, such as channel configuration 2006 for control channel 2008 or data channel 2010 in coverage area 110. The cell includes a plurality of non-contiguous frequency bands associated with different numerologies, such as illustrated for example in FIG. 8. The control channel or the data channel may be allocated in: one or more of the non-contiguous frequency bands associated with a single numerology of the different numerologies, such as illustrated and described with respect to any of FIG. 9A, 9B, 12A, 12B, or 16, or one or more of the non-contiguous frequency bands associated with each numerology of the different numerologies, such as illustrated and described with respect to any of FIG. 10, 11A-11C, 13, 14, 15A, 15B, 17, 18, or 19. For example, block 2102 may be performed by configuration component 2240. For instance, referring to the Figures, the controller(s)/processor(s) 359 or RX processor(s) 356 of UE at block 2102 may receive a signal from the base station. This signal contains the channel configuration information. The RX processor(s) 356 may demodulate the received signal to extract the channel configuration information. The controller(s)/processor(s) 359 may then process this information to understand the configuration of the control channel or data channel in the cell. This may involve interpreting the configuration information to determine the allocation of the control channel or data channel in the non-contiguous frequency bands associated with the different numerologies. The control channel may be a PDCCH or a PUCCH. The data channel may be a PDSCH or a PUSCH. The cell may be a virtual cell, such as virtual cell 802. The non-contiguous frequency bands may correspond to sub-bands 804 associated with different numerologies 806.

At block 2104, the UE may receive or transmit information in at least one of the control channel or the data channel based on the configuration, such as information 2018 in control channel 2008 or data channel 2010 based on channel configuration 2006. For example, block 2104 may be performed by information component 2242. For instance, referring to the Figures, in one example, the controller(s)/processor(s) 359, RX processor(s) 356, or TX processor(s) 368 of the UE may process the received channel configuration. This may involve interpreting the configuration to determine how the information should be prepared for transmission or reception. Based on the configuration, the TX processor(s) 368 or RX processor(s) 356 may then prepare the information for transmission or reception. This may involve encoding the information for transmission or decoding the received information. The UE may then transmit or receive the information in the allocated control channel or data channel. This may involve the TX processor(s) 368 modulating the information onto a carrier signal for transmission, or the RX processor(s) 356 demodulating the received signal to extract the information.

In various examples, when receiving or transmitting the information based on the configuration, the UE may apply the information contained in the channel configuration to determine how and when to transmit or receive information in the control or data channels. For instance, the channel configuration may specify the time periods (e.g., monitoring occasions, slots, or sub-frames) during which certain resources are configured or scheduled for the data and control channels. The UE may then use this information to determine, for example, when to monitor for the PDCCH, when to transmit the PUCCH, or when to receive the PDSCH or transmit the PUSCH. The channel configuration may also specify the time-frequency allocations of these resources in one or more of the sub-bands of the virtual cell. The UE may apply this information to determine the specific frequencies and time intervals at which to transmit or receive information in the control or data channels. Furthermore, the channel configuration may specify the quantities of blind decoding attempts and non-overlapped CCEs for PDCCH monitoring. The UE may apply this information to determine how many blind decoding attempts to make and how many non-overlapped CCEs to monitor when receiving the PDCCH. Moreover, the channel configuration may specify the numerologies associated with the different sub-bands of the virtual cell. The UE may apply this information to determine the subcarrier spacing and cyclic prefix length to use when transmitting or receiving information in the control or data channels.

In some examples, the control channel is a PDCCH, the configuration indicates to monitor the PDCCH in the one or more of the non-contiguous frequency bands associated with the single numerology of the different numerologies, and at block 2106, the UE may monitor the PDCCH in the one or more of the non-contiguous frequency bands associated with the single numerology. For example, as illustrated and described with respect to FIGS. 9A-9B and FIG. 20, in a virtual cell with different sub-bands and different numerologies, the UE may be semi-statically configured to monitor the PDCCH on one or multiple sub-bands with one numerology at block 2017.

In some examples, the configuration indicates a quantity of blind decoding attempts and a quantity of non-overlapped CCEs for PDCCH monitoring in a time period for the cell, the quantity of blind decoding attempts and the quantity of non-overlapped CCEs respectively being capped by a limit associated with the single numerology for the PDCCH. For example, as described with respect to FIGS. 9A-9B and FIG. 20, the number of blind decodes (B) and the number of non-overlapped CCEs (C) for PDCCH monitoring in a certain time period for the cell (e.g., time period 902, 952 such as PDCCH monitoring occasion, per slot, per sub-frame) may be configured in channel configuration 2006 by RRC signaling or defined by specifications. B and C may be limited by maximum numbers for the numerology, B_{max,μ}, C_{max,μ}, defined in 3GPP or reported by UE capability, where u denotes the index of the numerology (e.g., SCS=2^{μ} kHz) for the PDCCH.

In some examples, the control channel is a PDCCH, the configuration indicates to monitor the PDCCH in the one or more of the non-contiguous frequency bands associated with the each numerology of the different numerologies, and at block 2106, the UE may monitor the PDCCH in the one or more of the non-contiguous frequency bands associated with the single numerology during a time period. For example, as illustrated and described with respect to FIG. 10 and FIG. 20, in a virtual cell with different sub-bands and different numerologies, the UE may be configured to monitor the PDCCH on one or multiple sub-bands with more than one numerology at block 2017. However, the UE may be configured to monitor the PDCCH with one numerology at a given time period (e.g., time period 1002 such as per PDCCH monitoring occasion, slot, sub-frame).

In some examples, the configuration indicates a quantity of blind decoding attempts and a quantity of non-overlapped CCEs for PDCCH monitoring in the time period for the cell, the quantity of blind decoding attempts and the quantity of non-overlapped CCEs for the PDCCH respectively being capped by a limit associated with the single numerology during the time period. For example, as described with respect to FIGS. 10 and 20, the number of blind decodes (B) and the number of non-overlapped CCEs (C) for PDCCH monitoring in a certain time period for the cell (e.g., time period 1002 such as PDCCH monitoring occasion, per slot, per sub-frame) may be configured in channel configuration 2006 by RRC signaling or pre-defined. B and C for PDCCH monitoring in a time period for the cell (e.g., time period 1002 such as PDCCH monitoring occasion, per slot, per sub-frame) may be limited by maximum numbers for the numerology, B_{max,μ}, C_{max,μ}, pre-defined or reported by UE capability, where u denotes the index of the numerology (e.g., SCS=2^{μ} kHz) for the PDCCH at each time period (e.g., time period 1002 such as per PDCCH monitoring occasion, slot, sub-frame).

In some examples, the control channel is a PDCCH, the configuration indicates to monitor for the PDCCH in the one or more of the non-contiguous frequency bands associated with the each numerology of the different numerologies, and at block 2106, the UE may monitor the PDCCH in the one or more of the non-contiguous frequency bands associated with the each numerology of the different numerologies during a time period, where CCEs of the PDCCH are respectively mapped in resources associated with the single numerology. For example, as illustrated and described with respect to FIGS. 11A and 11B and 20, in a virtual cell with different sub-bands and different numerologies, the UE may be configured to monitor the PDCCH on one or multiple sub-bands with more than one numerology at a given time period (e.g., time period 1102 such as per PDCCH monitoring occasion, slot, sub-frame) at block 2017. However, the CCEs of a PDCCH candidate are mapped on resources with a single numerology such as illustrated in FIG. 11B. Thus, the resources of each PDCCH candidate do not span across multiple numerologies.

In some examples, the configuration indicates a quantity of blind decoding attempts and a quantity of non-overlapped CCEs for PDCCH monitoring in the time period for the cell for the each numerology of the different numerologies, the quantity of blind decoding attempts and the quantity of non-overlapped CCEs for the PDCCH respectively being capped by a limit associated with the each of the different numerologies during the time period. For example, as described with respect to FIGS. 11A and 11B and 20, the number of blind decodes (B) and the number of non-overlapped CCEs (C) for PDCCH monitoring in a certain time period for the cell for each numerology are configured in channel configuration 2006 by RRC signaling or pre-defined. B and C for PDCCH monitoring in a time period for the cell for each numerology such as time period 1102 may be limited by maximum numbers for the numerology, B_{max,μ}, C_{max,μ}, defined or reported by UE capability, where u denotes the index of the numerology (e.g., SCS=2^{μ} kHz) for the PDCCH at each time period of each numerology.

In some examples, the control channel is a PDCCH, the configuration indicates to monitor for the PDCCH in the one or more of the non-contiguous frequency bands associated with the each numerology of the different numerologies, and at block 2106, the UE may monitor the PDCCH in the one or more of the non-contiguous frequency bands associated with the each numerology of the different numerologies during a time period, where CCEs of the PDCCH are respectively mapped in resources associated with a set of the each numerologies. For example, as illustrated and described with respect to FIGS. 11A and 11C and 20, in a virtual cell with different sub-bands and different numerologies, the UE may be configured via channel configuration 2006 to monitor the PDCCH at block 2017 on one or multiple sub-bands with more than one numerology at a given time period such as time period 1102. However, the CCEs of a PDCCH candidate are mapped on resources with different numerologies such as illustrated in FIG. 11C. Thus, the resources of each PDCCH candidate may span across multiple numerologies.

In some examples, the configuration indicates a quantity of blind decoding attempts and a quantity of non-overlapped CCEs for PDCCH monitoring in the time period for the cell for the set of the each numerologies, the quantity of blind decoding attempts and the quantity of non-overlapped CCEs for the PDCCH respectively being capped by a limit associated with a reference numerology of the set of the each numerologies during the time period. For example, as described with respect to FIGS. 11A and 11C and 20, the number of blind decodes (B) and the number of non-overlapped CCEs (C) for PDCCH monitoring in a certain time period for the cell for a set of numerologies for the PDCCH are configured in channel configuration 2006 by RRC signaling or pre-defined. B and C for PDCCH monitoring in a time period such as time period 1102 for the cell for the set of numerologies for the PDCCH may be limited by maximum numbers for the numerology, B_{max,μ}_ref, C_{max,μ}_ref, defined or reported by UE capability, where μ_ref denotes a reference numerology (e.g., max SCS or min SCS of the set of numerologies for the PDCCH) for the PDCCH at each time period of the set of numerologies.

In some examples, the control channel is a PUCCH, and the configuration indicates a plurality of PUCCH resources respectively including one or more time-frequency resources associated with the single numerology of the different numerologies, the PUCCH resources being respectively allocated in the one or more of the non-contiguous frequency bands associated with the single numerology. For example, as illustrated and described with respect to FIGS. 12A and 12B and 20, in a virtual cell with different sub-bands and different numerologies, the UE may be configured with N PUCCH resources in channel configuration 2006. Each PUCCH resource is formed by one or multiple time/frequency resources in sub-band(s) with one numerology. All the N PUCCH resources are configured with the sub-band(s) with one numerology. Thus, all PUCCH resources in the UE are configured to use the same numerology.

In some examples, the control channel is a PUCCH, the configuration indicates a plurality of PUCCH resources respectively including one or more time-frequency resources associated with the single numerology of the different numerologies, the PUCCH resources being respectively allocated in the one or more of the non-contiguous frequency bands associated with the each numerology of the different numerologies, and at block 2108, the UE may transmit in one of the PUCCH resources allocated in the one or more of the non-contiguous frequency bands associated with the single numerology during a time period. For example, as illustrated and described with respect to FIGS. 13 and 20, in a virtual cell with different sub-bands and different numerologies, the UE may be configured with N PUCCH resources in channel configuration 2006. Each PUCCH resource is formed by one or multiple time-frequency resources in sub-band(s) with one numerology. However, some of the N PUCCH resources are configured with the sub-band(s) with one numerology and the other PUCCH resources are configured with the sub-band(s) with another numerology. Thus, the PUCCH resources in the UE may be configured to use different numerologies. Moreover, here, a UE may transmit a PUCCH on one of the numerologies at a given time, such as time period 1302. Thus, the UE would use one numerology for transmitting the PUCCH at any given time.

In some examples, the control channel is a PUCCH, the configuration indicates a plurality of PUCCH resources respectively including one or more time-frequency resources associated with the single numerology of the different numerologies, the PUCCH resources being respectively allocated in the one or more of the non-contiguous frequency bands associated with the each numerology of the different numerologies, and at block 2108, the UE may transmit in multiple ones of the PUCCH resources allocated in the one or more of the non-contiguous frequency bands associated with the each numerology of the different numerologies simultaneously during a single time period. For example, as illustrated and described with respect to FIGS. 14 and 20, in a virtual cell with different sub-bands and different numerologies, the UE may be configured with N PUCCH resources in channel configuration 2006. Each PUCCH resource is formed by one or multiple time-frequency resources in sub-band(s) with one numerology. However, some of the N PUCCH resources are configured with the sub-band(s) with one numerology and the other PUCCH resources are configured with the sub-band(s) with another numerology. Thus, the PUCCH resources in the UE may be configured to use different numerologies. Moreover, here, the UE may transmit multiple PUCCHs on multiple numerologies at a given time simultaneously, such as in time period 1402. The multiple PUCCHs at a given time period may carry different uplink control information (enabling large payload feedback), or they may carry the same uplink control information (enabling frequency diversity). Thus, the UE may use different numerologies for transmitting multiple PUCCHs at the same time, either to send different control information or to send the same control information over different frequencies for improved reliability.

In some examples, the control channel is a PUCCH, the configuration indicates a plurality of PUCCH resources respectively including one or more time-frequency resources associated with the each numerology of the different numerologies, one of the PUCCH resources being respectively allocated in the one or more of the non-contiguous frequency bands associated with the each numerology during different time periods. For example, as illustrated and described with respect to FIGS. 15A and 20, in a virtual cell with different sub-bands and different numerologies, the UE may be configured with N PUCCH resources in channel configuration 2006. Each PUCCH resource may be formed by one or multiple time-frequency resources in sub-band(s) with multiple numerologies. Thus, each PUCCH resource in the UE may be configured to use more than one numerology. Moreover, here, different numerologies for resources of a PUCCH resource may only be in the time-domain. For example, the first half of time-domain resources of a PUCCH resource is with numerology 1, and the second half of time-domain resources of the PUCCH resource is with numerology 2. Thus, the UE would use one numerology for the first half of the time period for transmitting the PUCCH, and a different numerology for the second half. As a result, the UE may achieve either frequency-diversity gain or payload/capacity increase, similar to the example of FIG. 14. Thus, using different numerologies for transmitting the PUCCH can either improve the reliability of the transmission by using different frequencies (frequency-diversity gain), or increase the amount of control information that can be sent (payload/capacity increase).

In some examples, the control channel is a PUCCH, the configuration indicates a plurality of PUCCH resources respectively including one or more time-frequency resources associated with the each numerology of the different numerologies, one of the PUCCH resources being respectively allocated in the one or more of the non-contiguous frequency bands associated with the each numerology during a same time period. For example, as illustrated and described with respect to FIGS. 15B and 20, in a virtual cell with different sub-bands and different numerologies, the UE may be configured with N PUCCH resources in channel configuration 2006. Each PUCCH resource may be formed by one or multiple time-frequency resources in sub-band(s) with multiple numerologies. Thus, each PUCCH resource in the UE may be configured to use more than one numerology. Moreover, here, different numerologies for resources of a PUCCH format may be in the frequency-domain. Thus, the UE may use different numerologies for transmitting the PUCCH over different frequencies. As a result, the UE may achieve either frequency-diversity gain or payload/capacity increase, similar to the example of FIG. 14. Thus, using different numerologies for transmitting the PUCCH may either improve the reliability of the transmission by using different frequencies (frequency-diversity gain), or increase the amount of control information that can be sent (payload/capacity increase).

In some examples, the data channel is a PDSCH or a PUSCH, at block 2110, the UE may receive DCI scheduling the PDSCH or the PUSCH in the one or more of the non-contiguous frequency bands associated with the single numerology of the different numerologies, at least one field of the DCI being configured for the single numerology, and at blocks 2112 or 2114 respectively, the UE may receive the PDSCH or transmit the PUSCH in the one or more of the non-contiguous frequency bands associated with the single numerology of the different numerologies, where different PDSCHs or different PUSCHs are respectively allocated in the one or more of the non-contiguous frequency bands associated with the different numerologies during different time periods. For example, as illustrated and described with respect to FIGS. 16 and 20, in a virtual cell with different sub-bands and different numerologies, the UE may receive a PDSCH or transmit a PUSCH on one or multiple sub-bands with one numerology. PDSCHs or PUSCHs in different time periods (e.g., time periods 1602 such as slot, sub-frame) may be on different sub-bands with different numerologies. The scheduler such as DCI 1604 ensures that a PDSCH or PUSCH is scheduled/mapped on sub-band(s) with the same numerology in the virtual cell. Depending on the numerology where the PDSCH or PUSCH is scheduled, the DCI fields/bits may be interpreted in different ways. For example, if a UE detects a DCI scheduling a PDSCH or PUSCH on sub-band(s) of a numerology, the DCI bits are interpreted such that the DCI fields are optimal for the sub-band(s) of the numerology (e.g., MCS, TPMI, TDRA, etc. for a numerology are configured in one DCI, and those for another numerology may be different in another DCI).

In some examples, the data channel is a PDSCH or a PUSCH, at block 2110, the UE may receive DCI scheduling the PDSCH or the PUSCH in the one or more of the non-contiguous frequency bands associated with the each numerology of the different numerologies, and at blocks 2112 or 2114 respectively, the UE may receive the PDSCH or transmit the PUSCH in the one or more of the non-contiguous frequency bands associated with the each numerology of the different numerologies, where individual code blocks in the PDSCH or the PUSCH are respectively allocated in the one or more of the non-contiguous frequency bands associated with the single numerology. For example, as illustrated and described with respect to FIGS. 17 and 20, in a virtual cell with different sub-bands and different numerologies, the UE may receive a PDSCH or transmit a PUSCH on one or multiple sub-bands with more than one numerology. A PDSCH or PUSCH is scheduled/mapped on sub-bands with different numerologies via DCI 1704. Codeblocks 1706 of a data/transport block are mapped for example via channel configuration 2006 on time/frequency resources such that a CB does not span sub-band(s) with different numerologies. Thus, each codeblock of data is confined to sub-bands with the same numerology.

In some examples, the control channel is a PUCCH and the data channel is a PUSCH, at block 2108, the UE may transmit the PUCCH in the one or more of the non-contiguous frequency bands associated with one or multiple of the different numerologies, and at block 2114, the UE may transmit the PUSCH, concurrently with the PUCCH, in a different one or more of the non-contiguous frequency bands associated with one or multiple of the different numerologies. For example, as illustrated and described with respect to FIGS. 18 and 20, in a virtual cell with different sub-bands and different numerologies, the UE may transmit a PUCCH on one or multiple sub-bands with one or multiple numerologies, and a PUSCH on different one or multiple sub-bands with one or multiple numerologies. This allows for simultaneous PUCCH-PUSCH transmissions on different sub-bands of a virtual cell.

In some examples, the data channel is a PUSCH and the control channel is a PUCCH concurrent in time with the PUSCH, and at block 2114, the UE may transmit the PUSCH in one or more of the non-contiguous frequency bands associated with one or multiple of the different numerologies, the PUCCH being multiplexed on the PUSCH in either: the one or more of the non-contiguous frequency bands associated with a reference numerology of the different numerologies, or the one or more of the non-contiguous frequency bands associated with the each numerology of the different numerologies. For example, as illustrated and described with respect to FIGS. 19 and 20, in a virtual cell with different sub-bands and different numerologies, the UE may transmit a PUSCH on one or multiple sub-bands with one or multiple numerologies where UCI of a concurrent PUCCH is piggybacked on the PUSCH. Thus, the control information from the PUCCH is included in the PUSCH transmission. In one example, UCI is multiplexed on the PUSCH on one or multiple sub-bands with a certain numerology. Thus, the control information is combined with the user data on the PUSCH on sub-bands with a specific numerology. The specific numerology or reference numerology may be either: the numerology with the lowest SCS, the numerology with the highest SCS is used, or the numerology associated with the same SCS as the PUCCH. In another example, UCI is multiplexed on the PUSCH on one or multiple sub-bands with multiple numerologies. Here, the same SCS(s) as the PUCCH may be used for the multiplexing. Thus, the control information is combined with the user data on the PUSCH on sub-bands with the same numerology as the PUCCH.

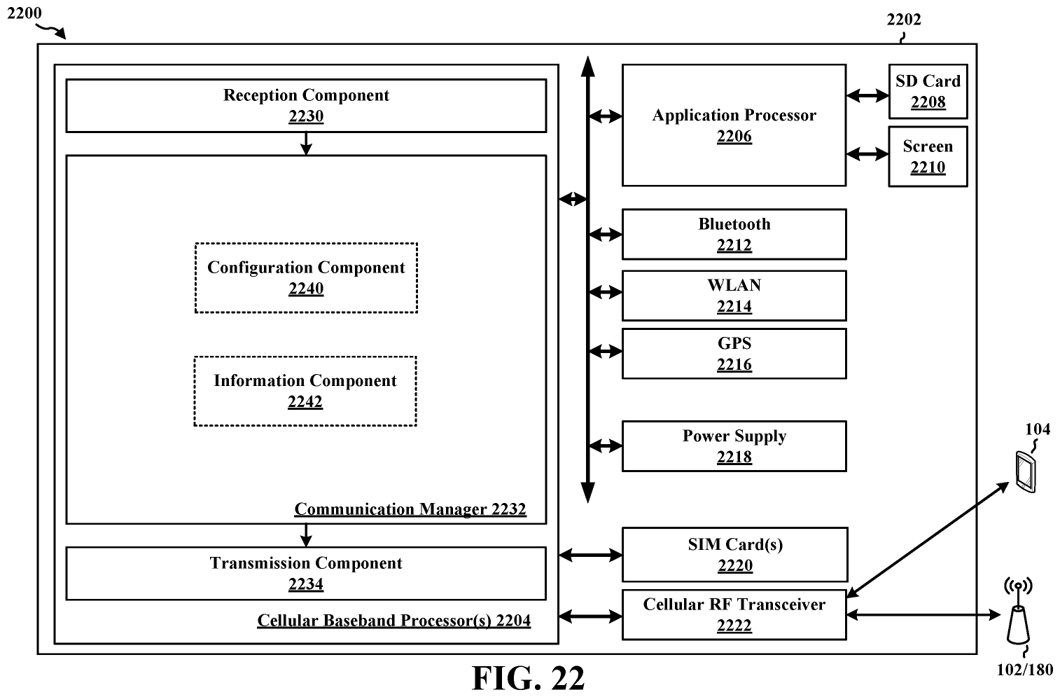

FIG. 22 is a diagram 2200 illustrating an example of a hardware implementation for an apparatus 2202 according to the various aspects of the present disclosure. In one example, the apparatus 2202 may be a UE such as UE 104, 350, 2004 and includes one or more cellular baseband processors 2204 (also referred to as a modem) coupled to a cellular RF transceiver 2222 and one or more subscriber identity modules (SIM) cards 2220, an application processor 2206 coupled to a secure digital (SD) card 2208 and a screen 2210, a Bluetooth module 2212, a wireless local area network (WLAN) module 2214, a Global Positioning System (GPS) module 2216, and a power supply 2218. The one or more cellular baseband processors 2204 communicate through the cellular RF transceiver 2222 with the BS 102. For example, the cellular RF transceiver 2222 may correspond to or include the transmitters 354TX, receivers 354RX, and antennas 352 of UE 350.

The one or more cellular baseband processors 2204 may each include a computer-readable medium/one or more memories. The computer-readable medium/one or more memories may be non-transitory. The one or more cellular baseband processors 2204 are responsible for general processing, including the execution of software stored on the computer-readable medium/one or more memories individually or in combination. The software, when executed by the one or more cellular baseband processors 2204, causes the one or more cellular baseband processors 2204 to, individually or in combination, perform the various functions described supra. The computer-readable medium/one or more memories may also be used individually or in combination for storing data that is manipulated by the one or more cellular baseband processors 2204 when executing software. The one or more cellular baseband processors 2204 individually or in combination further include a reception component 2230, a communication manager 2232, and a transmission component 2234. The communication manager 2232 includes the one or more illustrated components. The components within the communication manager 2232 may be stored in the computer-readable medium/one or more memories and/or configured as hardware within the one or more cellular baseband processors 2204. The one or more cellular baseband processors 2204 may be components of the UE 104, 350, 2004 and may individually or in combination include the one or more memories 360 and/or at least one of the one or more TX processors 368, at least one of the one or more RX processors 356 and at least one of the one or more controllers/processors 359. For example, the computer-readable medium/one or more memories may correspond to or include the one or more memories 360, the reception component 2230 may correspond to or include the one or more RX processors 356, the communication manager 2232 may correspond to or include the one or more controllers/processors 359, and the transmission component 2234 may correspond to or include the one or more TX processors 368. In one configuration, the apparatus 2202 may be a modem chip and include just the one or more baseband processors 2204, and in another configuration, the apparatus 2202 may be the entire UE (e.g., UE 350 of FIG. 3) and include the aforediscussed additional modules of the apparatus 2202.

The communication manager 2232 may include a configuration component 2240 that is configured to obtain a configuration of a control channel or a data channel in a cell, the cell including a plurality of non-contiguous frequency bands associated with different numerologies, the control channel or the data channel being allocated in: one or more of the non-contiguous frequency bands associated with a single numerology of the different numerologies, or one or more of the non-contiguous frequency bands associated with each numerology of the different numerologies, such as described in connection with block 2102 of FIG. 21. The communication manager 2232 may also include an information component 2242 that is configured to receive or transmit information in at least one of the control channel or the data channel based on the configuration, such as described in connection with block 2104 of FIG. 21.

The apparatus may include additional components that perform each of the blocks of the algorithm in the aforementioned flowcharts of FIGS. 20 and 21. As such, each block in the aforementioned flowcharts of FIGS. 20 and 21 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 2202, and in particular the one or more cellular baseband processors 2204, includes means for obtaining a configuration of a control channel or a data channel in a cell, the cell including a plurality of non-contiguous frequency bands associated with different numerologies, the control channel or the data channel being allocated in: one or more of the non-contiguous frequency bands associated with a single numerology of the different numerologies, or one or more of the non-contiguous frequency bands associated with each numerology of the different numerologies; and means for receiving or transmitting information in at least one of the control channel or the data channel based on the configuration.

The aforementioned means may be one or more of the aforementioned components of the apparatus 2202 configured to perform the functions recited by the aforementioned means. Moreover, as described supra, the apparatus 2202 may include the one or more TX Processors 368, the one or more RX Processors 370, and the one or more controllers/processors 359. As such, in one configuration, the aforementioned means may be at least one of the one or more TX Processors 368, at least one of the one or more RX Processors 356, or at least one of the one or more controllers/processors 359 individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.

Clause 1. An apparatus for wireless communication, comprising: one or more memories; and one or more processors each communicatively coupled with at least one of the one or more memories, the one or more processors, individually or in any combination, operable to cause the apparatus to: obtain a configuration of a control channel or a data channel in a cell, the cell including a plurality of non-contiguous frequency bands associated with different numerologies, the control channel or the data channel being allocated in: one or more of the non-contiguous frequency bands associated with a single numerology of the different numerologies, or one or more of the non-contiguous frequency bands associated with each numerology of the different numerologies; and receive or transmit information in at least one of the control channel or the data channel based on the configuration.

Clause 2. The apparatus of clause 1, wherein the control channel is a physical downlink control channel (PDCCH), the configuration indicates to monitor the PDCCH in the one or more of the non-contiguous frequency bands associated with the single numerology of the different numerologies, and the one or more processors, individually or in any combination, are operable to cause the apparatus to: monitor the PDCCH in the one or more of the non-contiguous frequency bands associated with the single numerology.

Clause 3. The apparatus of clause 2, wherein the configuration indicates a quantity of blind decoding attempts and a quantity of non-overlapped control channel elements (CCEs) for PDCCH monitoring in a time period for the cell, the quantity of blind decoding attempts and the quantity of non-overlapped CCEs respectively being capped by a limit associated with the single numerology for the PDCCH.

Clause 4. The apparatus of any of clauses 1 to 3, wherein the control channel is a physical downlink control channel (PDCCH), the configuration indicates to monitor the PDCCH in the one or more of the non-contiguous frequency bands associated with the each numerology of the different numerologies, and the one or more processors, individually or in any combination, are operable to cause the apparatus to: monitor the PDCCH in the one or more of the non-contiguous frequency bands associated with the single numerology during a time period.

Clause 5. The apparatus of clause 4, wherein the configuration indicates a quantity of blind decoding attempts and a quantity of non-overlapped control channel elements (CCEs) for PDCCH monitoring in the time period for the cell, the quantity of blind decoding attempts and the quantity of non-overlapped CCEs for the PDCCH respectively being capped by a limit associated with the single numerology during the time period.

Clause 6. The apparatus of any of clauses 1 to 5, wherein the control channel is a physical downlink control channel (PDCCH), the configuration indicates to monitor for the PDCCH in the one or more of the non-contiguous frequency bands associated with the each numerology of the different numerologies, and the one or more processors, individually or in any combination, are operable to cause the apparatus to: monitor the PDCCH in the one or more of the non-contiguous frequency bands associated with the each numerology of the different numerologies during a time period, wherein control channel elements (CCEs) of the PDCCH are respectively mapped in resources associated with the single numerology.

Clause 7. The apparatus of clause 6, wherein the configuration indicates a quantity of blind decoding attempts and a quantity of non-overlapped CCEs for PDCCH monitoring in the time period for the cell for the each numerology of the different numerologies, the quantity of blind decoding attempts and the quantity of non-overlapped CCEs for the PDCCH respectively being capped by a limit associated with the each of the different numerologies during the time period.

Clause 8. The apparatus of any of clauses 1 to 7, wherein the control channel is a physical downlink control channel (PDCCH), the configuration indicates to monitor for the PDCCH in the one or more of the non-contiguous frequency bands associated with the each numerology of the different numerologies, and the one or more processors, individually or in any combination, are operable to cause the apparatus to: monitor the PDCCH in the one or more of the non-contiguous frequency bands associated with the each numerology of the different numerologies during a time period, wherein control channel elements (CCEs) of the PDCCH are respectively mapped in resources associated with a set of the each numerologies.

Clause 9. The apparatus of clause 8, wherein the configuration indicates a quantity of blind decoding attempts and a quantity of non-overlapped CCEs for PDCCH monitoring in the time period for the cell for the set of the each numerologies, the quantity of blind decoding attempts and the quantity of non-overlapped CCEs for the PDCCH respectively being capped by a limit associated with a reference numerology of the set of the each numerologies during the time period.

Clause 10. The apparatus of any of clauses 1 to 9, wherein the control channel is a physical uplink control channel (PUCCH), and the configuration indicates a plurality of PUCCH resources respectively including one or more time-frequency resources associated with the single numerology of the different numerologies, the PUCCH resources being respectively allocated in the one or more of the non-contiguous frequency bands associated with the single numerology.

Clause 11. The apparatus of any of clauses 1 to 10, wherein the control channel is a physical uplink control channel (PUCCH), the configuration indicates a plurality of PUCCH resources respectively including one or more time-frequency resources associated with the single numerology of the different numerologies, the PUCCH resources being respectively allocated in the one or more of the non-contiguous frequency bands associated with the each numerology of the different numerologies, and the one or more processors, individually or in any combination, are operable to cause the apparatus to: transmit in one of the PUCCH resources allocated in the one or more of the non-contiguous frequency bands associated with the single numerology during a time period.

Clause 12. The apparatus of any of clauses 1 to 11, wherein the control channel is a physical uplink control channel (PUCCH), the configuration indicates a plurality of PUCCH resources respectively including one or more time-frequency resources associated with the single numerology of the different numerologies, the PUCCH resources being respectively allocated in the one or more of the non-contiguous frequency bands associated with the each numerology of the different numerologies, and the one or more processors, individually or in any combination, are operable to cause the apparatus to: transmit in multiple ones of the PUCCH resources allocated in the one or more of the non-contiguous frequency bands associated with the each numerology of the different numerologies simultaneously during a single time period.

Clause 13. The apparatus of any of clauses 1 to 12, wherein the control channel is a physical uplink control channel (PUCCH), the configuration indicates a plurality of PUCCH resources respectively including one or more time-frequency resources associated with the each numerology of the different numerologies, one of the PUCCH resources being respectively allocated in the one or more of the non-contiguous frequency bands associated with the each numerology during different time periods.

Clause 14. The apparatus of any of clauses 1 to 13, wherein the control channel is a physical uplink control channel (PUCCH), the configuration indicates a plurality of PUCCH resources respectively including one or more time-frequency resources associated with the each numerology of the different numerologies, one of the PUCCH resources being respectively allocated in the one or more of the non-contiguous frequency bands associated with the each numerology during a same time period.

Clause 15. The apparatus of any of clauses 1 to 14, wherein the data channel is a physical downlink shared channel (PDSCH) or a physical uplink shared channel (PUSCH), and the one or more processors, individually or in any combination, are operable to cause the apparatus to: receive downlink control information (DCI) scheduling the PDSCH or the PUSCH in the one or more of the non-contiguous frequency bands associated with the single numerology of the different numerologies, at least one field of the DCI being configured for the single numerology; receive the PDSCH or transmit the PUSCH in the one or more of the non-contiguous frequency bands associated with the single numerology of the different numerologies, wherein different PDSCHs or different PUSCHs are respectively allocated in the one or more of the non-contiguous frequency bands associated with the different numerologies during different time periods.

Clause 16. The apparatus of any of clauses 1 to 15, wherein the data channel is a physical downlink shared channel (PDSCH) or a physical uplink shared channel (PUSCH), and the one or more processors, individually or in any combination, are operable to cause the apparatus to: receive downlink control information (DCI) scheduling the PDSCH or the PUSCH in the one or more of the non-contiguous frequency bands associated with the each numerology of the different numerologies; receive the PDSCH or transmit the PUSCH in the one or more of the non-contiguous frequency bands associated with the each numerology of the different numerologies, wherein individual code blocks in the PDSCH or the PUSCH are respectively allocated in the one or more of the non-contiguous frequency bands associated with the single numerology.

Clause 17. The apparatus of any of clauses 1 to 16, wherein the control channel is a physical uplink control channel (PUCCH) and the data channel is a physical uplink shared channel (PUSCH), and the one or more processors, individually or in any combination, are operable to cause the apparatus to: transmit the PUCCH in the one or more of the non-contiguous frequency bands associated with one or multiple of the different numerologies; and transmit the PUSCH, concurrently with the PUCCH, in a different one or more of the non-contiguous frequency bands associated with one or multiple of the different numerologies.

Clause 18. The apparatus of any of clauses 1 to 17, wherein the data channel is a physical uplink shared channel (PUSCH) and the control channel is a physical uplink control channel (PUCCH) concurrent in time with the PUSCH, and the one or more processors, individually or in any combination, are operable to cause the apparatus to: transmit the PUSCH in one or more of the non-contiguous frequency bands associated with one or multiple of the different numerologies, the PUCCH being multiplexed on the PUSCH in either: the one or more of the non-contiguous frequency bands associated with a reference numerology of the different numerologies, or the one or more of the non-contiguous frequency bands associated with the each numerology of the different numerologies.

Clause 19. A method of wireless communication performable at a user equipment (UE), comprising: obtaining a configuration of a control channel or a data channel in a cell, the cell including a plurality of non-contiguous frequency bands associated with different numerologies, the control channel or the data channel being allocated in: one or more of the non-contiguous frequency bands associated with a single numerology of the different numerologies, or one or more of the non-contiguous frequency bands associated with each numerology of the different numerologies; and receiving or transmitting information in at least one of the control channel or the data channel based on the configuration.

Clause 20. An apparatus for wireless communication, comprising: means for obtaining a configuration of a control channel or a data channel in a cell, the cell including a plurality of non-contiguous frequency bands associated with different numerologies, the control channel or the data channel being allocated in: one or more of the non-contiguous frequency bands associated with a single numerology of the different numerologies, or one or more of the non-contiguous frequency bands associated with each numerology of the different numerologies; and means for receiving or transmitting information in at least one of the control channel or the data channel based on the configuration.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
obtain a configuration of a control channel or a data channel in a cell, the cell including a plurality of non-contiguous frequency bands associated with different numerologies, the control channel or the data channel being allocated in:
one or more of the non-contiguous frequency bands associated with a single numerology of the different numerologies, or
one or more of the non-contiguous frequency bands associated with each numerology of the different numerologies; and
receive or transmit information in at least one of the control channel or the data channel based on the configuration.

2. The apparatus of claim 1, wherein the control channel is a physical downlink control channel (PDCCH), the configuration indicates to monitor the PDCCH in the one or more of the non-contiguous frequency bands associated with the single numerology of the different numerologies, and the one or more processors, individually or in any combination, are operable to cause the apparatus to:
monitor the PDCCH in the one or more of the non-contiguous frequency bands associated with the single numerology.

3. The apparatus of claim 2, wherein the configuration indicates a quantity of blind decoding attempts and a quantity of non-overlapped control channel elements (CCEs) for PDCCH monitoring in a time period for the cell, the quantity of blind decoding attempts and the quantity of non-overlapped CCEs respectively being capped by a limit associated with the single numerology for the PDCCH.

4. The apparatus of claim 1, wherein the control channel is a physical downlink control channel (PDCCH), the configuration indicates to monitor the PDCCH in the one or more of the non-contiguous frequency bands associated with the each numerology of the different numerologies, and the one or more processors, individually or in any combination, are operable to cause the apparatus to:
monitor the PDCCH in the one or more of the non-contiguous frequency bands associated with the single numerology during a time period.

5. The apparatus of claim 4, wherein the configuration indicates a quantity of blind decoding attempts and a quantity of non-overlapped control channel elements (CCEs) for PDCCH monitoring in the time period for the cell, the quantity of blind decoding attempts and the quantity of non-overlapped CCEs for the PDCCH respectively being capped by a limit associated with the single numerology during the time period.

6. The apparatus of claim 1, wherein the control channel is a physical downlink control channel (PDCCH), the configuration indicates to monitor for the PDCCH in the one or more of the non-contiguous frequency bands associated with the each numerology of the different numerologies, and the one or more processors, individually or in any combination, are operable to cause the apparatus to:
monitor the PDCCH in the one or more of the non-contiguous frequency bands associated with the each numerology of the different numerologies during a time period, wherein control channel elements (CCEs) of the PDCCH are respectively mapped in resources associated with the single numerology.

7. The apparatus of claim 6, wherein the configuration indicates a quantity of blind decoding attempts and a quantity of non-overlapped CCEs for PDCCH monitoring in the time period for the cell for the each numerology of the different numerologies, the quantity of blind decoding attempts and the quantity of non-overlapped CCEs for the PDCCH respectively being capped by a limit associated with the each of the different numerologies during the time period.

8. The apparatus of claim 1, wherein the control channel is a physical downlink control channel (PDCCH), the configuration indicates to monitor for the PDCCH in the one or more of the non-contiguous frequency bands associated with the each numerology of the different numerologies, and the one or more processors, individually or in any combination, are operable to cause the apparatus to:
monitor the PDCCH in the one or more of the non-contiguous frequency bands associated with the each numerology of the different numerologies during a time period, wherein control channel elements (CCEs) of the PDCCH are respectively mapped in resources associated with a set of the each numerologies.

9. The apparatus of claim 8, wherein the configuration indicates a quantity of blind decoding attempts and a quantity of non-overlapped CCEs for PDCCH monitoring in the time period for the cell for the set of the each numerologies, the quantity of blind decoding attempts and the quantity of non-overlapped CCEs for the PDCCH respectively being capped by a limit associated with a reference numerology of the set of the each numerologies during the time period.

10. The apparatus of claim 1, wherein the control channel is a physical uplink control channel (PUCCH), and the configuration indicates a plurality of PUCCH resources respectively including one or more time-frequency resources associated with the single numerology of the different numerologies, the PUCCH resources being respectively allocated in the one or more of the non-contiguous frequency bands associated with the single numerology.

11. The apparatus of claim 1, wherein the control channel is a physical uplink control channel (PUCCH), the configuration indicates a plurality of PUCCH resources respectively including one or more time-frequency resources associated with the single numerology of the different numerologies, the PUCCH resources being respectively allocated in the one or more of the non-contiguous frequency bands associated with the each numerology of the different numerologies, and the one or more processors, individually or in any combination, are operable to cause the apparatus to:
transmit in one of the PUCCH resources allocated in the one or more of the non-contiguous frequency bands associated with the single numerology during a time period.

12. The apparatus of claim 1, wherein the control channel is a physical uplink control channel (PUCCH), the configuration indicates a plurality of PUCCH resources respectively including one or more time-frequency resources associated with the single numerology of the different numerologies, the PUCCH resources being respectively allocated in the one or more of the non-contiguous frequency bands associated with the each numerology of the different numerologies, and the one or more processors, individually or in any combination, are operable to cause the apparatus to:
transmit in multiple ones of the PUCCH resources allocated in the one or more of the non-contiguous frequency bands associated with the each numerology of the different numerologies simultaneously during a single time period.

13. The apparatus of claim 1, wherein the control channel is a physical uplink control channel (PUCCH), the configuration indicates a plurality of PUCCH resources respectively including one or more time-frequency resources associated with the each numerology of the different numerologies, one of the PUCCH resources being respectively allocated in the one or more of the non-contiguous frequency bands associated with the each numerology during different time periods.

14. The apparatus of claim 1, wherein the control channel is a physical uplink control channel (PUCCH), the configuration indicates a plurality of PUCCH resources respectively including one or more time-frequency resources associated with the each numerology of the different numerologies, one of the PUCCH resources being respectively allocated in the one or more of the non-contiguous frequency bands associated with the each numerology during a same time period.

15. The apparatus of claim 1, wherein the data channel is a physical downlink shared channel (PDSCH) or a physical uplink shared channel (PUSCH), and the one or more processors, individually or in any combination, are operable to cause the apparatus to:
receive downlink control information (DCI) scheduling the PDSCH or the PUSCH in the one or more of the non-contiguous frequency bands associated with the single numerology of the different numerologies, at least one field of the DCI being configured for the single numerology; and
receive the PDSCH or transmit the PUSCH in the one or more of the non-contiguous frequency bands associated with the single numerology of the different numerologies, wherein different PDSCHs or different PUSCHs are respectively allocated in the one or more of the non-contiguous frequency bands associated with the different numerologies during different time periods.

16. The apparatus of claim 1, wherein the data channel is a physical downlink shared channel (PDSCH) or a physical uplink shared channel (PUSCH), and the one or more processors, individually or in any combination, are operable to cause the apparatus to:
receive downlink control information (DCI) scheduling the PDSCH or the PUSCH in the one or more of the non-contiguous frequency bands associated with the each numerology of the different numerologies; and
receive the PDSCH or transmit the PUSCH in the one or more of the non-contiguous frequency bands associated with the each numerology of the different numerologies, wherein individual code blocks in the PDSCH or the PUSCH are respectively allocated in the one or more of the non-contiguous frequency bands associated with the single numerology.

17. The apparatus of claim 1, wherein the control channel is a physical uplink control channel (PUCCH) and the data channel is a physical uplink shared channel (PUSCH), and the one or more processors, individually or in any combination, are operable to cause the apparatus to:
transmit the PUCCH in the one or more of the non-contiguous frequency bands associated with one or multiple of the different numerologies; and
transmit the PUSCH, concurrently with the PUCCH, in a different one or more of the non-contiguous frequency bands associated with one or multiple of the different numerologies.

18. The apparatus of claim 1, wherein the data channel is a physical uplink shared channel (PUSCH) and the control channel is a physical uplink control channel (PUCCH) concurrent in time with the PUSCH, and the one or more processors, individually or in any combination, are operable to cause the apparatus to:
transmit the PUSCH in one or more of the non-contiguous frequency bands associated with one or multiple of the different numerologies, the PUCCH being multiplexed on the PUSCH in either:
the one or more of the non-contiguous frequency bands associated with a reference numerology of the different numerologies, or
the one or more of the non-contiguous frequency bands associated with the each numerology of the different numerologies.

19. A method of wireless communication performable at a user equipment (UE), comprising:
obtaining a configuration of a control channel or a data channel in a cell, the cell including a plurality of non-contiguous frequency bands associated with different numerologies, the control channel or the data channel being allocated in:
one or more of the non-contiguous frequency bands associated with a single numerology of the different numerologies, or
one or more of the non-contiguous frequency bands associated with each numerology of the different numerologies; and
receiving or transmitting information in at least one of the control channel or the data channel based on the configuration.

20. An apparatus for wireless communication, comprising:
means for obtaining a configuration of a control channel or a data channel in a cell, the cell including a plurality of non-contiguous frequency bands associated with different numerologies, the control channel or the data channel being allocated in:
one or more of the non-contiguous frequency bands associated with a single numerology of the different numerologies, or
one or more of the non-contiguous frequency bands associated with each numerology of the different numerologies; and
means for receiving or transmitting information in at least one of the control channel or the data channel based on the configuration.
